(19) United States
(12) Patent Application Publication
(10) Pub. No.: US 2026/0263981 A1
(43) Pub. Date: Sep. 10, 2026

(54) FILTER ELEMENTS, RELATED FILTER ASSEMBLY AND FILTER PACKAGE

(71) Applicant: Donaldson Company, Inc., Bloomington, MN (US)

(72) Inventors: Bart CATOOR, Kessel-Lo (BE); Mathijs VERSTRAETE, Tienen (BE); Anthonius Jan-Baptist Maria MOERS, Holsbeek (BE); Kristof DECOSTER, Vilvoorde (BE); Gunther VAN DE POEL, Waanrode (BE); Walther DE CROMBRUGGHE, Leuven (BE); Gert PROOST, Kessel-lo (BE); Jeroen CLAES, Lueven (BE); Johan DeWit, Den Haag (NL); Marc DE WOLF, Tielt-Winge (BE)

(73) Assignee: Donaldson Company, Inc., Bloomington, MN (US)

(21) Appl. No.: 19/491,310

(22) PCT Filed: Jun. 7, 2024
(86) PCT No.: PCT/US2024/033073

§ 371 Date: Dec. 8, 2025

Related U.S. Application Data
(60) Provisional application No. 63/507,039, filed on Jun. 8, 2023.

(30) Foreign Application Priority Data
Nov. 29, 2023 (EP) 23213143.3

(51) Int. Cl. B01D 46/24; B01D 46/00; B01D 46/42

(52) U.S. Cl. CPC B01D 46/2414; B01D 46/0098; B01D 46/4227; B01D 2265/06; B01D 2271/027

(57) ABSTRACT

The present disclosure relates to a filter element comprising a filtration media pack comprising a longitudinal axis, a first open end cap arranged at a first axial end of the filtration media pack comprising a central opening, wherein the first end cap is at least partially flexible and non-destructively deformable in a radial direction, and comprises a circumferential seal circumferentially surrounding the opening, wherein the circumferential seal comprises one or more radial seal extensions; and one or more, preferably separate, reinforcement structures at least partially embedded into a material of the first end cap and preferably arranged in respective areas of the one or more radial seal extensions.

### RELATED APPLICATION

This application claims priority to United States Provisional Patent Application Ser. No. 63/507,039, filed on Jun. 8, 2023, the entirety of which is incorporated by reference herein. This application also claims priority to European Patent Application Serial Number 23213143.3, filed on Nov. 29, 2023, the entirety of which is incorporated by reference herein.

### FIELD OF THE DISCLOSURE

The present disclosure relates to the field of gas filtration, such as, for instance, air filtration. It relates to the field of filter assemblies comprising a filter element which is arranged in a filter housing in a sealing manner, such that air passing from an inlet of the housing to an outlet of the housing is filtered by the filter element. Preferably the assemblies are used for filtering air that is afterwards directed to an engine of, for instance, a vehicle.

### BACKGROUND

Filter elements, also named filter cartridges, are used for a wide variety of filtering applications and the fluid to be filtered can be a liquid or a gas, e.g., air.

Indeed, in many instances, it is desired to filter contaminant material from a fluid stream. For example, airflow streams to engines for motorized vehicles or for power generation equipment, construction equipment, or other equipment, gas streams to gas turbine systems and air streams to various combustion furnaces, carry particulate contaminant therein. It is preferred for such systems that contaminant materials be removed from the fluid or at least be reduced.

Filter elements comprise filter media for removing contaminant materials when the fluid flows through the filter media. Commonly used and commercially available filter media are, for example, pleated media or fluted media. When the filter media is loaded with dust and/or particles above a certain threshold load, a filter element needs to be replaced. Filter elements are typically installed in the housing in a replaceable manner.

There is a need in industry for new solutions which allow an easy installation of a correct filter element in a filter housing, especially complex filter housing designs, and which would not allow the installation of a wrong filter element. Complex filter housing designs can, for instance, be a result of boundary conditions imposed by the geometry and positioning of other vehicle/engine components.

There is also a need in industry for compact packaging of filter elements and filter housings.

And, there is a need in industry for filter elements that have an increased ratio of filter media volume over internal housing volume.

Further, solutions that reduce filter element weight and amount of used material are appreciated in industry, both for economic as well as ecologic purposes.

Also, there exists a need for filter housings and assemblies that allow an easy removal of a housing cover, and that facilitate a correct positioning of the housing cover on a housing.

It is generally important to install correct filter elements, in a correct manner, for a certain filter housing in order to avoid damage to the equipment or engine which makes use of the filtered air/gas.

There is also a need in industry for filter assemblies that allow an installed filter element to be inspected from the inside without the need to remove the element.

There is also a need in industry for filter assemblies that allow inspection of an installed filter element with a reduced risk of breaking the sealing of the filter element towards the main housing.

### SUMMARY

The present disclosure is directed to a filter element, a package comprising such a filter element, an assembly comprising such filter element and a housing cover for advantageous use with such a filter element.

The present invention is defined in the appended independent claims. The dependent claims define advantageous embodiments.

In a first aspect of the present disclosure, a filter element is disclosed comprising a filtration media pack comprising a longitudinal axis, and a first open end cap arranged at a first axial end of the filtration media pack in a fluid tight manner and comprising a central opening. The first end cap is at least partially flexible and non-destructively, preferably elastically, deformable in a radial direction, for instance, between a first shape (or state; for instance, an undeformed state, corresponding to a first configuration of the element) and a substantially different second shape (or state; for instance, a deformed state, such as when a curved side or portion becomes flattened or curved in the opposite direction, corresponding to a second configuration of the element), and comprises: a circumferential seal surrounding the opening, wherein the circumferential seal comprises one or more radial seal extensions (seal extensions in the radial direction); and one or more, preferably separate, reinforcement structures (or covering structures or shells) at least partially embedded into a material of the first end cap and preferably arranged in respective areas of the one or more radial seal extensions.

The one or more, preferably separate, reinforcement structures can be arranged at the respective locations of the radial seal extensions.

The reinforcement structures can be partially or fully embedded into a material of the first end cap. In examples, one or more reinforcement structures are separately formed and placed into a mold for the first end cap such that the end cap material is overmolded onto portions of the reinforcement structures. In examples, the material for the one or more reinforcement structures is different than a material for the first end cap. In some examples, the reinforcement structures can be formed separately and attached to the end cap by various means. For example, the reinforcement structures can be formed with interacting features to snap in or slide into corresponding features of the end cap, such as with a projection and groove arrangement. The reinforcement structures can also be connected or otherwise adhered or attached to the end cap by other means, for example adhesives and mechanical fasteners. The reinforcement structures can also be attached via a welding process.

According to preferred embodiments, the one or more reinforcement structures are partially embedded into a material of the first end cap, each reinforcement structure covering at least a portion of a corresponding radial extension of the seal, the portion comprising at least a radially inner or outer surface of the radial seal extension and preferably a first axial end surface of the radial extension, the first axial end surface projecting towards a second axial end of the filtration media pack.

It is an advantage that filter housings can be designed that allow for the installation of the disclosed filter element but that do not allow installation of standard filter elements, avoiding the use of a wrong filter element or a wrong installation thereof. It is a further advantage that the disclosed filter element can be used in relatively complex and compact housing configurations. Moreover, the disclosed filter element can be packaged in a more compact manner.

According to preferred embodiments, the filtration media pack is also flexible and non-destructively, possibly elastically, deformable, for instance, in a radial direction. This can, for instance, be the case when the filtration media comprises pleated media arranged in a tubular manner.

Such filter elements do not comprise a rigid inner or outer liner, which would reduce or jeopardize the flexibility and elasticity of the first end cap. Inner and outer liners are typically provided to support the filtration media in use, when subject to substantial differential pressures.

It is an advantage that a filter element without integrated inner and/or outer liner comprises less material, can be manufactured more easily and at lower cost, and is more environmentally friendly.

In alternative embodiments, the filtration media pack is itself not flexible and/or non-destructively deformable, and the end cap is arranged and adapted for being flexible and non-destructively deformable. This can, for instance, be the case when the filtration media comprises fluted (also called z-type) media (which does not comprise inner and/or outer liners).

For the purpose of the present disclosure, the filter element, seal, end cap, or filter media pack can non-destructively be deformed if a deformation of the respective item does not impact the integrity or performance thereof. Preferably, the respective item is flexible and even more preferably, the respective item is elastically deformable, within the boundaries needed for performing its function, e.g., for being reduced in size in order to enter a service or other opening of a filter housing which is initially too small or, to shape itself according to a filter housing cavity which has enough volume but which is shaped differently. An item is elastically deformable if it returns to its original undeformed state after having been deformed.

It is an advantage that an elastically deformable end cap automatically returns in its original position, resulting in a corresponding first configuration of the filter element, after the end cap and optionally filter media pack have been deformed, for instance, for installing the filter element in an air cleaner housing or packaging.

For the purpose of the present disclosure, a circumferential seal (or sealing surface) is a seal (or sealing surface) that makes a circumference or is around a respective opening, such as the central opening or the first end cap, respectively. Circumferential seals and associated circumferential sealing surfaces in a filter housing cooperate in order to provide an air-tight seal.

For the purpose of the present disclosure, a “composite structure” refers to a combination of a radial extension and associated reinforcement structure.

According to preferred embodiments, the circumferential seal is adapted and arranged for sealing in a radial direction, and the reinforcement structures are arranged and adapted for backing the radial seal extension of the circumferential seal.

According to preferred embodiments, a thickness of the seal measured in a direction perpendicular to the axial direction is substantially constant or constant. In some examples, the seal thickness is variable. In some examples, the thickness of the seal material at the location of the radial seal extensions is relatively thinner than at other locations.

According to preferred embodiments, a thickness of the seal measured in a direction perpendicular to the axial direction is within the range of 5 mm to 20 mm.

According to preferred embodiments, one or more or all radial seal extensions are extending radially outwardly. In cases where the thickness of the seal measured in a direction perpendicular to the axial direction is substantially constant or constant, the one or more radial seal extensions comprise a radially outward step.

According to preferred embodiments, one or more or all radial seal extensions are extending radially inwardly. In cases where the thickness of the seal measured in a direction perpendicular to the axial direction is substantially constant or constant, the one or more radial seal extensions comprise a radially inward step.

The relative height of the step of the radial seal extensions, measured radially between the inner surface of the seal in extended position and the virtual contour of the seal without seal extensions at the position of the respective seal extensions, is preferably between 25% and 200%, or between 50% and 150% of the constant thickness of the seal measured in a direction perpendicular to the axial direction. According to certain embodiments, the height of the step of the radial seal extensions is the same or about the same as the constant thickness of the seal measured in a direction perpendicular to the axial direction.

The absolute height of the step of the radial seal extensions can be, for instance, between 1 mm and 40 mm, or between 2 mm and 20 mm, or between 5 mm and 15 mm, not excluding larger values.

According to certain embodiments, one or more radial seal extensions are extending radially inwardly, and one or more radial seal extensions are extending radially outwardly. In certain embodiments, there are two radial seal extensions, one of them extending inwardly and the other extending outwardly.

According to preferred embodiments, the seal generally follows, for instance, is in axial projection generally concentric with, an outer and/or inner contour of the filtration media pack, except for the one or more radial seal extensions.

According to preferred embodiments, the seal in the first configuration of the end cap can have a cross-section along a plane perpendicular to the filter element which is circular, rectangular, rounded rectangular, obround, oval, or can have other regular shapes, except for the one or more radial seal extensions.

According to preferred embodiments, the two or more radial seal extensions are congruent, for instance, having the same thickness (axial extent) and width (angular extent) and depth (radial extent; in the direction of the height of the step). For instance, the axial projections of the one or more radial seal extensions can be congruent. In alternative embodiments, the axial projections of two or more radial seal extensions differ in one or more of width and depth.

According to preferred embodiments, a minimal radial cross-dimension of the second shape of the first open end cap is at least 5%, or at least 10%, or at least 15%, or at least 20%, or at least 25%, or at least 30 % smaller than a minimal radial cross-dimension of the first shape.

According to preferred embodiments, a minimal radial cross-dimension of the second shape of the first open end cap is at least 5 mm, or at least 10 mm, or at least 15 mm, or at least 20 mm, or at least 25 mm, or at least 5 cm smaller than a minimal radial cross-dimension of the first shape of the first open end cap.

According to preferred embodiments, the filter element comprises only two radial seal extensions which are arranged at diametrically opposed sides of the circumferential seal.

According to preferred embodiments, the distance between the (e.g., two) radial seal extensions in the second shape is at least 5%, or at least 10%, or at least 15%, or at least 20%, or at least 25%, or at least 30 % smaller than the distance in the first shape.

For instance, the distance between the (e.g., two) radial seal extensions in the second shape is at least 5 mm, or at least 10 mm, or at least 15 mm, or at least 20 mm, or at least 25 mm, or at least 5 cm smaller than the distance in the first shape.

In certain embodiments, the seal extensions can be brought closer to one another by deforming the seal, for instance, in order to install the seal extensions below an undercut (of, for instance, a cavity) or in a cavity in a filter housing, after which the seal extensions snap outwardly into a predetermined position in a filter housing when released.

According to preferred embodiments, distance between the (e.g., two) radial seal extensions in the second shape is at least 5%, or at least 10%, or at least 15%, or at least 20%, or at least 25%, or at least 30 % larger than the distance in the first shape.

For instance, the distance between the (e.g., two) radial seal extensions in the second shape is at least 5 mm, or at least 10 mm, or at least 15 mm, or at least 20 mm, or at least 25 mm, or at least 5 cm larger than the distance in the first shape.

In certain embodiments, the distance between the seal extensions can be increased by deforming the seal, for instance, in order to install the seal extensions below an undercut (of, for instance, a cavity) or in a cavity in a filter housing, after which the seal extensions snap inwardly into a predetermined position in a filter housing when released.

According to preferred embodiments, the first end cap can be deformed in a radial direction (for instance, for more than 5%, or more than 10%, or more than 15%) by radial force components which are smaller than 40 N, or smaller than 30 N, or smaller than 20 N or smaller than 10N. To further illustrate, a filter element can be provided with a media pack and mounted first end cap having a first width, at a first location of the radial seal extension(s) and reinforcing structure(s), when in the first shape, and can have a second width at the first location, when in the second shape. In some examples, for example, when the filter element is provided without an inner and without an outer liner, the end cap and media pack can be non-destructively deformed in a radial direction such that the second width is at least 5% different from the first width with an applied radial force component of 25 N or less, and in some cases 15 N or less. In some examples, the second width is at least 10% different from the first width with an applied radial force component of 45 N or less, and in some cases 25 N or less.

According to preferred embodiments, the reinforcement structures are made of a relatively hard material. Preferably, the reinforcement structures comprise materials which are from medium hard to hard and up to extra hard. To express and measure the hardness of a material, the known shore-A durometer scale or shore-D durometer scale can be used. In embodiments, the reinforcement structures have a durometer either measured on a shore-A scale between 60 and 100, preferably between 70 and 100, more preferably between 80 and 100 or, alternatively, when measured on a shore-D scale, between 0 and 100, preferably between 15 and 100, more preferably between 30 and 100. In examples, the reinforcement structures have a material hardness that is greater than a material hardness of the portion of the end cap forming the seal.

In embodiments, the reinforcement structures comprise or are made of hard plastic.

In other embodiments, the reinforcement structures comprise a thermoplastic, such as, for example, acrylonitrile butadiene styrene (ABS), polypropylene (PP), polyamide (PA) or polyvinyl chloride (PVC).

The deformable end cap is thus not (e.g., radially) deformable in the regions of the reinforcement structures or shells, but is deformable outside of the regions of the shells to accommodate radial displacement of the reinforcement structures. Similarly, the deformable end cap is also not (e.g., radially) deformable in the regions of the radial seal extensions. Stated another way, each reinforcement structure provides structural integrity to a portion of the end cap such that the end cap will radially deform at adjacent locations when the reinforcement structure is displaced radially inwardly.

According to preferred embodiments, each reinforcement structure comprises a hollow cavity in a second axial end surface thereof, the second axial end surface projecting (or being exposed) in the same direction as the first end of the filtration media pack.

According to preferred embodiments, the second axial end surface is opposed to the first axial end surface in an axial direction.

Preferably, the hollow cavity is blind and has an axis parallel to the longitudinal axis of the filter element, having an opening that points away from the media pack.

According to preferred embodiments, the filtration media pack comprises pleated filtration media, preferably arranged in a tubular manner, and is flexible and preferably elastically deformable. For instance, the filtration media comprises one or more layers selected from the group of media layers and media support layers. The latter provide support for keeping the media together and in place without pressure difference, and differ from liner structures in that liners are suitable for keeping the filtration media in place during use and when subject to substantial pressure difference.

Preferably, the pleated media is arranged in a tubular manner having a pleat direction parallel to a longitudinal filter element axis in at least the first configuration of the element.

According to other embodiments, the filtration media pack is of the fluted or z-type and can, for instance, be wound or stacked.

According to preferred embodiments, the first end cap and preferably also the circumferential seal, is/are manufactured by a potting process, preferably a foamed polyurethane potting process, whereby a portion of the one or more separate reinforcement structures are embedded in the first end cap.

Preferably, the circumferential seal is formed integrally with the first end cap.

Preferably, the circumferential seal comprises or consists of polyurethane (e.g., foamed polyurethane).

In certain embodiments, the first end cap and/or the circumferential seal comprises or consists of TPE (thermoplastic elastomer).

According to preferred embodiments, the first circumferential seal comprises a two-fold rotational symmetry with respect to the filtration media pack axis.

According to preferred embodiments, the first circumferential seal comprises a single-fold rotational symmetry with respect to the filtration media pack axis.

According to certain embodiments, the filter element comprises an axially extending groove in a radially outer surface of the media pack, preferably extending from the first end to the second end.

According to certain embodiments, the filter element comprises a second end cap at a second end of the filtration media pack. The second end cap can be a closed or an open end cap. In case the second end cap is open, it can comprise a central opening and a second circumferential seal. The second end cap can be rigid or can be flexible and non-destructively deformable, and, for instance, elastically deformable. The second end cap and optionally second circumferential seal can comprise the same materials as the first end cap, and can generally be manufactured in the same way as the first end cap.

In certain embodiments, the second end cap can be configured according to any of the embodiments disclosed in relation to the first end cap.

In a second aspect of the present disclosure, a package is disclosed comprising a box, bag, or sleeve comprising a filter element according to any of the embodiments of the first aspect, wherein the filter element is kept in an elastically deformed configuration by an inner sidewall of the box, bag, or sleeve.

In a third aspect of the present disclosure, filter assemblies are disclosed that are configured for making use of the filter elements according to certain embodiments of the first aspect of the present disclosure in an advantageous manner.

Generally, a filter assembly is disclosed comprising a filter housing adapted and arranged for receiving a filter element according to any of the embodiments of the first aspect, wherein the filter housing comprises one or more undercuts or cavities for receiving the composite structures of the filter element, whereby the associated filter element can only be installed (and thus the composite structures can only be received) by deforming the first end cap of the filter element.

According to a certain embodiment, a filter assembly is disclosed comprising a filter housing having an inlet opening and an outlet opening, and an internal cavity receiving a filter element according to any of the embodiments of the first aspect in a sealing manner thereby dividing the internal cavity into a unfiltered air volume fluidly connected to the inlet and a filtered air volume fluidly connected to the outlet by the filtration element, wherein the filter housing comprises a main filter housing and a housing cover, wherein the housing cover comprises an outer liner structure for the filter element having a longitudinal axis and projecting from the housing cover into the internal cavity, the outer liner structure receiving the filter element and comprising a proximal end at the housing cover and an opposed distal end, and the outer liner structure comprising one or more cavities at its distal end, adapted and arranged for receiving respective one or more composite structures embodied by the one or more radial seal extensions and associated reinforcement structures.

In certain embodiments, the filter element comprises an axially extending groove in a radially outer surface of the media pack, and wherein the outer liner structure comprises a corresponding axially extending rib or guiding structure arranged on an internal surface of the outer liner.

According to a certain embodiment, a filter assembly is disclosed comprising a filter housing having an inlet opening and an outlet opening, and an internal cavity receiving a filter element according to any of the embodiments of the first aspect in a sealing manner, thereby dividing the internal cavity into a unfiltered air volume fluidly connected to the inlet and a filtered air volume fluidly connected to the outlet by the filtration element, wherein the filter housing comprises a main filter housing and a housing cover, wherein the main filter housing comprises a filter servicing opening defined by a circumferential end portion of the main filter housing, wherein the circumferential end portion comprises one or more receiving cavities for receiving respective composite structures embodied by respective radial seal extensions and associated reinforcement structures of the filter element.

In certain embodiments, the reinforcement structures comprise radially outwardly extending ribs, and the cavities comprise corresponding cavity slots for receiving the radially outwardly extending ribs and allowing the radially outwardly extending ribs to pass though and to be exposed outside of the main housing, wherein the housing cover comprises latches, the latches latching on respective exposed portions of the radially outwardly extending ribs.

According to a certain embodiment, a filter assembly is disclosed comprising a filter housing having an inlet opening and an outlet opening, and an internal cavity receiving a filter element according to any of the embodiments of the first aspect in a sealing manner, thereby dividing the internal cavity into a unfiltered air volume fluidly connected to the inlet and a filtered air volume fluidly connected to the outlet by the filtration element, wherein the filter housing comprises a main filter housing and a housing cover, wherein the main filter housing comprises an inner liner for the filter element having a longitudinal axis and projecting from the main housing into the internal cavity, the inner liner structure being received by an internal cavity of the filter element and comprising a proximal end at the main housing and an opposed distal end, and the inner liner comprising one or more cavities at its distal end, adapted and arranged for receiving respective one or more composite structures embodied by the one or more radial seal extensions and associated reinforcement structures.

According to a certain embodiment, a filter assembly is disclosed comprising a filter element according to any of the embodiments of the first aspect and a separate, removable outer liner for the filter element, wherein the outer liner extends in an axial direction between a first axial end and a second axial end and comprises an internal volume for receiving the filter element, wherein the outer liner comprises one or more cavities at the first axial end receiving the one or more respective composite structures embodied by respective radial seal extensions and associated reinforcement structures of the filter element.

According to a certain embodiment, a filter assembly is disclosed comprising a filter element according to any of the embodiments of the first aspect and a separate, removable inner liner for the filter element, wherein the inner liner extends in an axial direction between a first axial end and a second axial end, and the filter element comprises an internal volume for receiving the inner liner, wherein the inner liner comprises one or more cavities at the first axial end receiving the one or more respective composite structures embodied by respective radial seal extensions and associated reinforcement structures of the filter element.

Preferably, in any of the above filter assembly embodiments, one or more cavities form an undercut portion preventing the composite structures from being inserted into the cavities without deforming the filter element.

According to a certain embodiment, a filter assembly is disclosed comprising a filter housing having an inlet opening and an outlet opening, and an internal cavity receiving a filter element according to any of the embodiments of the first aspect in a sealing manner, thereby dividing the internal cavity into a unfiltered air volume fluidly connected to the inlet and a filtered air volume fluidly connected to the outlet by the filtration element, wherein the filter housing comprises a main filter housing and a housing cover, wherein the housing cover comprises an outer liner structure for the filter element having a longitudinal axis and projecting from the housing cover into the internal cavity, the outer liner structure receiving the filter element and comprising a proximal end at the housing cover and an opposed distal end, and the outer liner structure comprising one or more undercut portions at its distal end, adapted and arranged for preventing the composite structures embodied by the one or more radial seal extensions and associated reinforcement structures from passing from one side to the opposed side of the undercut portions without deforming the filter element.

In certain embodiments, the filter element comprises an axially extending groove in a radially outer surface of the media pack, and wherein the outer liner structure comprises a corresponding axially extending rib or guiding structure arranged on an internal surface of the outer liner.

In some example embodiments, an air cleaner assembly includes a housing, a cover, and a media pack, in which an outer support structure and/or an inner support structure for the media pack is partially or wholly included in the cover.

In some example embodiments, an air cleaner assembly includes a housing, a cover, and a media pack, in which an inner support structure for the media pack is included in the cover, and in which the air cleaner assembly has a side-load configuration in which the media pack is installed through a service opening in a sidewall of the housing.

In some example embodiments, an air cleaner assembly includes a housing, a cover, and a media pack, in which an inner support structure for the media pack includes locking means for securing the cover to the housing.

In some example embodiments, an air cleaner assembly includes a housing, a cover, and a media pack, in which the media pack has a seal member with a radially outwardly directed seal surface and in which an inner support structure for the media pack extends along a radially inward side of the seal member.

In one example configuration, a side-load air cleaner assembly can include a main housing extending along a longitudinal axis, the main housing defining an internal volume and a service opening extending through a side of the main housing such that the service opening is generally orthogonal to the longitudinal axis; a media pack insertable within the main housing internal volume through the service opening, the media pack including a tubular filter media having an open interior area and extending between a first end cap and a second end cap; and a cover including a cover part for covering the service opening and including an inner support structure extending into the open interior area of the filter media.

In some examples, the inner support structure is separable from the cover part.

In some examples, the inner support structure includes locking means for securing the cover part to the main housing.

In some examples, the media pack first end cap defines a seal member defining a radially outward facing seal surface forming a seal with a radially inward facing seal surface of the main housing.

In some examples, the inner support structure extends within a radially interior side of the seal member such that the seal member is located radially between the inner support structure and the main housing.

In some examples, the second end cap forms a seal with the inner support structure.

In some examples, the second end cap is an open end cap and the inner support structure closes the open end cap.

In some examples, an outer support structure is provided and extends about and supports an outer perimeter of the filter media.

In some examples, the outer support structure is pivotally secured to the main housing.

In one example, an air cleaner assembly can include a main housing defining an internal volume and a service opening; a media pack insertable within the main housing internal volume through the service opening, the media pack including a filter media and a first end cap; and a cover including a cover part for covering the service opening and including an outer support structure at least partially surrounding an outer perimeter of the filter media.

In some examples, the cover part is rotatable with respect to the main housing.

In some examples, the outer support structure is integrally formed with the cover part.

In some examples, the outer support structure is separable from the cover part.

In some examples, the first end cap defines a seal member defining a radially outward facing seal surface forming a seal with a radially inward facing seal surface of the main housing.

In some examples, the main housing defines a service opening extending through a side of the main housing such that the service opening is generally orthogonal to the longitudinal axis.

In some examples, an inner support structure extends into an open area of the filter media.

In some examples, the inner support structure is attachable to the outer support structure.

In some examples, the inner support structure includes locking means for securing the cover to the main housing.

In some examples, the outer support structure includes a first part associated with the cover part and a second part associated with the main housing, the first and second parts cooperating to support the outer perimeter of the filter media.

In some examples, an inner support structure extends into an open area of the filter media.

In some examples, the inner support structure is rotatably secured to the main housing.

In some examples, the cover part includes a first cover part attached to or formed with the outer support structure and a second cover part attached to or formed with the inner support structure.

In some examples, the outer support structure circumscribes the entire perimeter of the media pack.

In some examples, the outer support structure includes an undercut feature securing the media pack within the outer support structure such that the media pack must be deformed in order to remove the media pack from the outer support structure.

A filter cartridge can include a tubular filter media defining an open interior and extending between a first end and a second end, the tubular filter media tapering in a direction towards the first end and having an obround shape; a first open end cap proximate the filter media first end and including a first seal member defining a first radially directed seal surface; a second open end cap proximate the filter media second end and including a second seal member defining a second radially directed seal surface; wherein the filter media is unsupported and is provided without an inner liner and without an outer liner such that the filter media and at least one of the first and second open end caps are elastically deformable.

In some examples, the first end cap includes a groove for receiving an end of an inner liner.

In some examples, the first radially directed sealing surface is a radially outward directed sealing surface.

A filter element can include a filtration media pack comprising a longitudinal axis; and a first open end cap arranged at a first axial end of the filtration media pack in a fluid tight manner and comprising a central opening, the first open end cap including a circumferential seal surrounding said opening, wherein said circumferential seal comprises a radial seal extension; and wherein the first end cap is non-destructively deformable in a first radial direction between a non-deformed state and a deformed state, wherein the end cap has a first width along a first axis passing through the longitudinal axis and the radial seal extension when in the first shape and a second width along the first axis when in the deformed state, wherein the second width is at least 5% different from the first width with an applied radial force component of 25 N or less.

In some examples, the second width is at least 10% different from the first width with an applied radial force of 45 N or less.

In some examples, a reinforcement structure is secured to the end cap proximate the radial seal extension, the reinforcement structure preventing deformation of the radial seal extension when the first end cap is in the deformed state.

In some examples, the first end cap has a third width extending along a second axis orthogonal to the first axis and passing through the longitudinal axis, wherein the first end cap can be deformed from the non-deformed state to the deformed state without requiring a change in the third width.

In some examples, the air filter element is provided without an inner liner and/or without an outer liner.

In some examples, the first end cap has single fold symmetry.

The present invention is defined, at least in part, in the appended independent claims. The dependent claims define advantageous embodiments.

### BRIEF DESCRIPTION OF THE DRAWINGS

These and further aspects of the present disclosure will be explained in greater detail by way of example and with reference to the accompanying drawings in which:

FIGS. 1a and 1b, FIG. 2 to FIG. 4, FIGS. 5a to 5c, FIGS. 6a and 6b, FIG. 7, and FIGS. 8a and 8b illustrate an embodiment of the present disclosure.

FIGS. 1a and 1b are perspective views of a filter assembly according to an embodiment of the present disclosure.

FIG. 2 is a top perspective view of a filter element installed in an outer liner of an outer liner cover according to an embodiment of the present disclosure.

FIG. 3 is an axial cut view of a filter assembly according to an embodiment of the present disclosure.

FIG. 4 is a perspective axial cut view of the filter assembly according to an embodiment of the present disclosure.

FIGS. 5a and 5b are perspective views of the filter element according to an embodiment of the present disclosure. FIG. 5c is a perspective cut view.

FIGS. 6a, 6b, and FIG. 7 are partially cut perspective views of the filter assembly according to an embodiment of the present disclosure.

FIG. 8a is a partially cut perspective view of a main housing part according to an embodiment of the present disclosure.

FIG. 8b is a partially transparent perspective view of the main housing part according to an embodiment of the present disclosure.

FIGS. 9a to 9c illustrate a preferred production process for a filter element according to various embodiments.

FIGS. 10a and 10b illustrate optional features for a housing cover according to various embodiments.

FIG. 11a is a partial cut perspective view and FIG. 11b is a perspective view of a filter assembly according to an embodiment of the present disclosure.

FIGS. 12a and 12b are perspective views of an assembly according to an embodiment of the present disclosure. FIG. 12d is an axial cut view, and FIG. 12c is a detail thereof.

FIGS. 13a to 13c are perspective views of an assembly according an embodiment of the present disclosure.

FIGS. 14a to 14c are perspective views of a main housing with a filter element, a filter element, and an outer liner cover, respectively, according to an embodiment of the present disclosure.

FIGS. 15a and 15b are perspective views of an assembly according to an embodiment of the present disclosure. FIG. 15d is an axial cut view, and FIG. 15c is a detail thereof.

FIGS. 16a and 16e are perspective views of an assembly according to an embodiment of the present disclosure. FIG. 16b is a detail of FIG. 16a. FIG. 16c is an axial cut view, and FIG. 16d is a detail thereof.

FIGS. 17a and 17b are perspective views of an assembly according to an embodiment of the present disclosure.

FIGS. 18a and 18b are perspective views of an assembly according to an embodiment of the present disclosure.

FIGS. 19a and 19b are perspective views of an assembly according an embodiment of the present disclosures.

FIG. 20 is a bottom view of an assembly according to an embodiment of the present disclosure.

FIGS. 21 to 23 are perspective views of alternative filter elements for use in assemblies of the present disclosure. FIG. 23 also illustrates an interaction with a main housing part.

FIGS. 24 to 30a are views of a filter element for use in assemblies of the present disclosure.

FIGS. 31a to 33b are schematic views illustrating elastic deformation aspects of the filter elements disclosed herein.

FIGS. 34a to 34f are schematic views of an example air cleaner assembly having features in accordance with the present disclosure.

FIGS. 35a to 35d are schematic views of an of an air cleaner assembly having features in accordance with the present disclosure.

FIGS. 36a to 36c are schematic views of an example air cleaner assembly having features in accordance with the present disclosure.

FIGS. 37a to 37c are schematic views of an example air cleaner assembly having features in accordance with the present disclosure.

FIGS. 38a to 38f are schematic views of an example air cleaner assembly having features in accordance with the present disclosure.

FIGS. 39a to 39e are schematic views of an example air cleaner assembly having features in accordance with the present disclosure.

FIGS. 40a to 40c are schematic views of an example air cleaner assembly having features in accordance with the present disclosure.

FIGS. 41a to 41e are schematic views of an example air cleaner assembly having features in accordance with the present disclosure.

FIGS. 42a to 42c are schematic views of an example air cleaner assembly having features in accordance with the present disclosure.

FIGS. 43a and 43b are schematic views of an example air cleaner assembly having features in accordance with the present disclosure.

FIGS. 44a to 44c are schematic views of sealing arrangements and configurations usable with the embodiments of the present disclosure.

FIGS. 45a to 45d are schematic views of an example air cleaner assembly having features in accordance with the present disclosure.

FIG. 46 is a schematic view of an example air cleaner assembly having features in accordance with the present disclosure.

The drawings of the figures are neither drawn to scale nor proportioned. Generally, identical components are denoted by the same reference numerals in the figures.

### DETAILED DESCRIPTION

The present disclosure will be described in terms of specific embodiments, which are illustrative of the disclosure and not to be construed as limiting. It will be appreciated by persons skilled in the art that the present disclosure is not limited by what has been particularly shown and/or described and that alternatives or modified embodiments could be developed in the light of the overall teaching of this disclosure. The drawings described are only schematic and are non-limiting.

Use of the verb “to comprise”, as well as the respective conjugations, does not exclude the presence of elements other than those stated. Use of the article “a”, “an” or “the” preceding an element does not exclude the presence of a plurality of such elements.

Furthermore, the terms first, second, and the like in the description and in the claims, are used for distinguishing between similar elements and not necessarily for describing a sequence, either temporally, spatially, in ranking, or in any other manner. It is to be understood that the terms so used are interchangeable under appropriate circumstances and that the embodiments of the disclosure described herein are capable of operation in other sequences than described or illustrated herein.

Reference throughout this specification to “one embodiment” or “an embodiment” means that a particular feature, structure or characteristic described in connection with the embodiments is included in one or more embodiment of the present disclosure. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one ordinary skill in the art from this disclosure, in one or more embodiments.

As used herein, the term “axially” generally refers to a direction that is parallel to the longitudinal axis X while the term “radially” generally refers to a direction that is orthogonal to the longitudinal axis X. As also used herein, the term “radially inward” generally refers to a direction facing towards the longitudinal axis X, while the term “radially outward” generally refers to a direction facing away from the longitudinal axis X.

Although a number of the drawings presented and discussed below are specifically addressing embodiments of a filter element for filtering air, the present disclosure is not limited thereto.

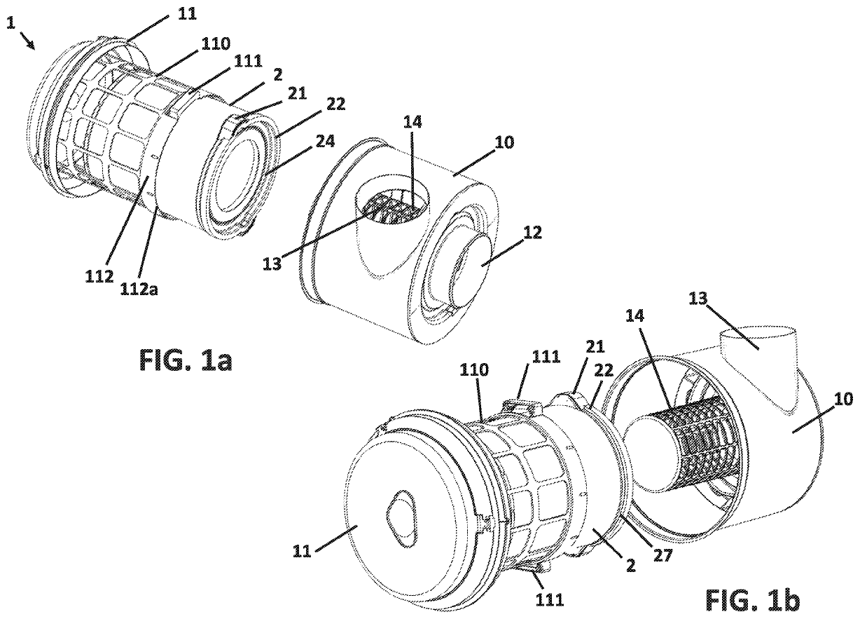

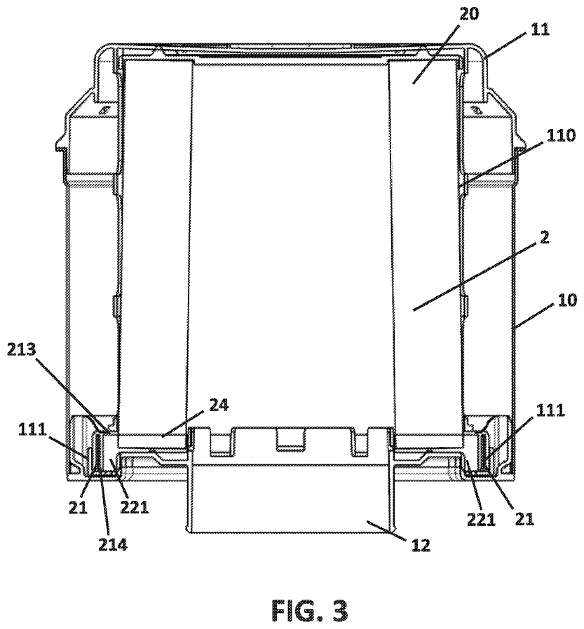

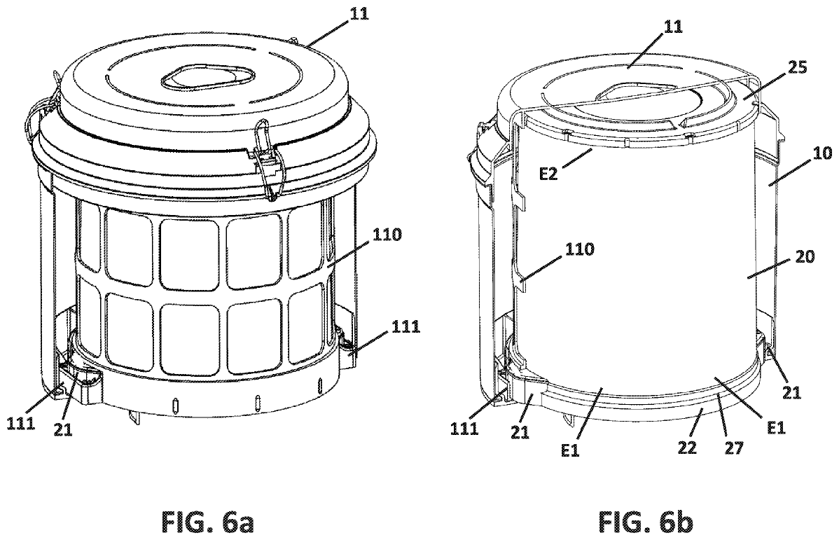

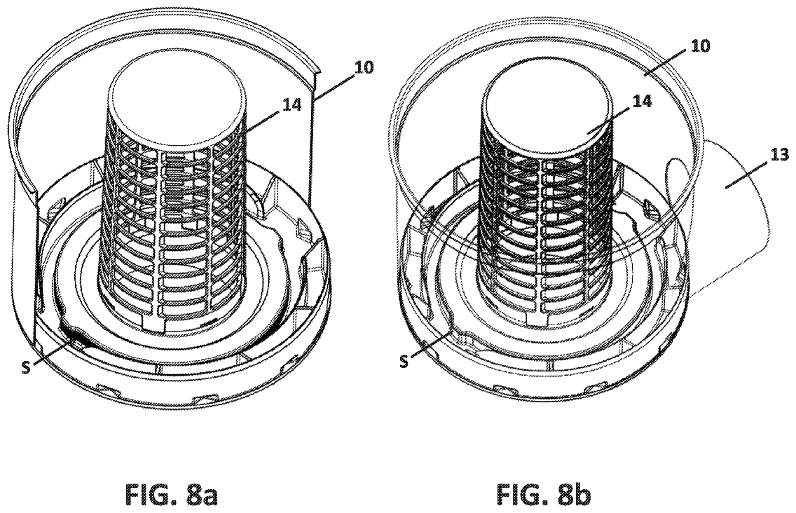

### Embodiment of FIGS. 1 to 8b

FIGS. 1a and 1b, FIG. 2 to FIG. 4, FIGS. 5a to 5c, FIGS. 6a and 6b, FIG. 7, and FIGS. 8a and 8b illustrate a first preferred embodiment of the present disclosure.

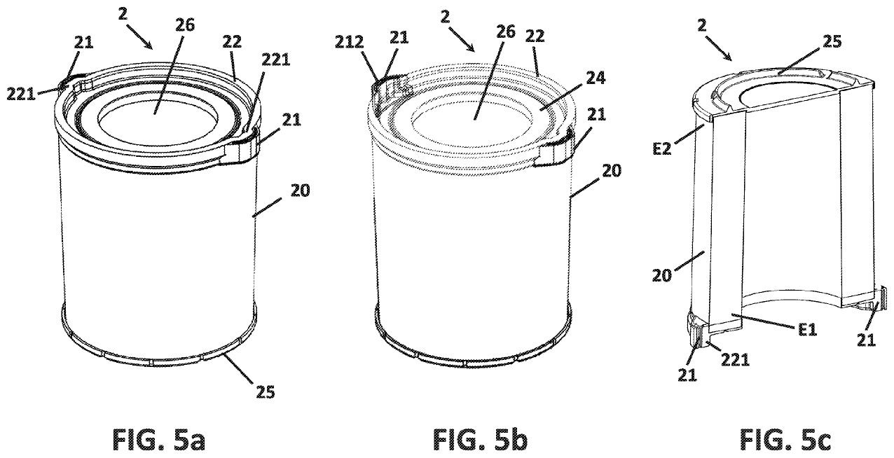

FIGS. 5a to 5c illustrate a filter element 2 according to a first preferred embodiment of the present disclosure. Filter element 2 comprises a filtration media pack 20 comprising a longitudinal axis, a first open end cap 24 arranged at a first axial end E1 of the media pack 20 in a fluid tight manner, and comprises a central opening 26. At a second axial end E2 of the filtration media pack 20, a second end cap 25 is provided in a fluid tight manner, which is a closed end cap 25. The first end cap 24 is at least partially flexible, elastically and nondestructively deformable in at least a radial direction, for instance, between a first shape and a substantially different second shape. The filter element further comprises a circumferential seal 22 surrounding the central opening 26. The circumferential seal comprises two radial seal extensions 221. It further comprises two separate reinforcement structures 21 partially embedded into the material of the first end cap 24. Each reinforcement structure 21 covers at least a portion of a corresponding radial extension 221 of the seal 22, comprising a radial outer surface 215 and a first axial end surface 213 of the radial extension 221. The first axial end surface 213 projects towards the second axial end E2 of the filtration media pack 20. As noted elsewhere, the filter element 2 may be configured to have a single radial extension 221 and reinforcement structure 21. It is noted that an outer perimeter of the first end cap 24 has a continuously shaped outer perimeter profile, in this case a circular profile, but for the presence of reinforcement structures 21. Accordingly, each reinforcement structure 21 can be characterized as forming an outwardly radially extending deviation segment or portion of the outer perimeter profile of the first end cap 21. In the example shown, the reinforcement structures 21 have a generally trapezoidal shape with rounded corners to define the deviation segment or portion. However, the reinforcement structures 21 of this disclosure can be provided with other shapes, such as rectangular shapes, irregularly curved shapes, arc shapes, semicircular shapes, semi-hexagonal shapes, and other half polygonal or near polygonal type shapes. With such a characterization, the first end cap 21 can be said to have a continuous outer perimeter profile that is interrupted by one or more deviation segments which may extend in a radially outward direction.

Circumferential seal 22 is adapted and arranged for sealing in a radially inward direction. The reinforcement structures 21 are arranged and adapted for backing the radial extension 221 of the circumferential seal 22. a thickness of seal 22 measured in a direction perpendicular to the axial direction is constant. At the location of the two reinforcement structures 21, seal 22 thus makes respective radially outward steps.

The seal 22 generally follows the outer contour of the filtration media pack 20, except at the two radial seal extensions 221. Axial projections of the seal 22 and the outer wall of the filtration media pack are concentric, except for the portions corresponding to the two radial seal extensions 221.

Composite structures comprising the radial seal extensions 221 and reinforcement structures 21 are arranged at diametrically opposed sides of the circumferential seal 22.

Each reinforcement structure 21 comprises one or more hollow cavities 212 in a second axial end surface 214 thereof, the second axial end surface 214 projecting in the same direction as the first end E1 of the filtration media pack. These hollow cavities 212 play a role in the production process and are exposed at a first end of filter element 2.

The filtration media pack 20 comprises pleated filtration media arranged in a tubular, cylindrical manner, and is flexible. It does not comprise rigid inner or outer liners 14, 110.

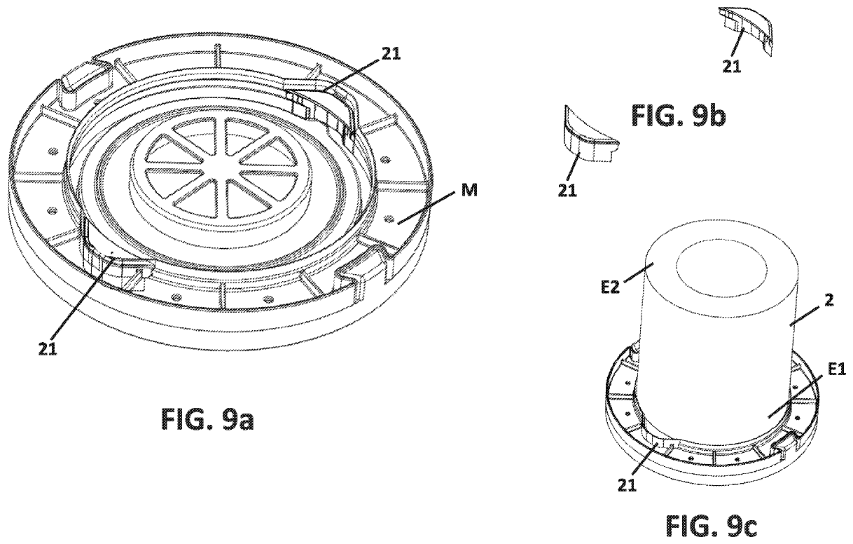

The end cap 24 is a potted polyurethane end cap, which is molded onto the pleated filtration media pack 20 and has the seal 22 integrated. A suitable molding process is illustrated in FIG. 9. Mold M (FIG. 9a) is provided which defines the shape of the end cap 24, the seal 22, and the radial seal extensions 221. The mold M comprises coupling structures (such as protrusions or pins) at predetermined locations, for being received by the hollow cavities 212 of the reinforcement structures 21 (FIG. 9b). As a result, the separate reinforcement structures 21 (e.g., made of a hard plastic material) can be positioned in a predetermined and stable position in the mold M. The pleated filtration media pack 20 is positioned into the mold (FIG. 9c) with a first axial end thereof. Finally, a polyurethane material is poured into the mold and cured to form the end cap 24, bond the filtration media to the end cap 24, and embed a portion of the reinforcement structures 21.

The end cap 24 (together with the pleated filtration media pack 20) is elastically deformable, meaning that when it is deformed and released, it returns to its original shape. The function thereof will now be explained in relation to the description of the assembly as depicted in FIGS. 1a and 1b, FIG. 2 to FIG. 4, and FIG. 6 to FIG. 8.

Also, optionally, the first end cap 24 further comprises a peripheral circumferential chamfered, pushing surface 27 positioned adjacent to, preferably directly adjacent to, that surrounds the outer wall of the media pack 20, and is interrupted only by respective portions of the reinforcement structures 21. The chamfered pushing surface 27 faces the second end E2 of the media pack 20 and extends from a position radially closer to the outer wall of the filtration media pack 20 to a position radially further removed from the outer wall of the filtration media pack 20 when moving towards the first end of the filtration media pack 20 or filter element 2.

Alternatively, also optionally, the first end cap 24 further comprises a peripheral circumferential pushing surface 27 that faces the second end E2 of the media pack 20 and is positioned adjacent to, preferably directly adjacent to, and surrounding the outer wall of the media pack 20 and is interrupted only by respective portions of the reinforcement structures 21. This pushing surface 27 can be planar and substantially perpendicular to the filtration media pack axis or filter element axis. The pushing surface can, for instance, also comprise a circumferential groove opening towards the second end E2 of the filtration media pack 20.

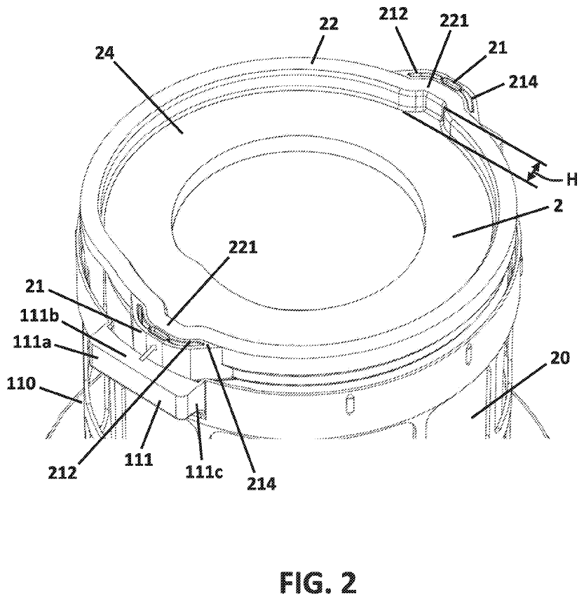

A first preferred embodiment of an assembly for use with the disclosed filter elements comprises a filter housing 10, 11 having an inlet opening 13 and an outlet opening 12, and an internal cavity receiving the disclosed filter element 2 in a sealing manner, thereby dividing the internal cavity into an unfiltered air volume fluidly connected to the inlet and a filtered air volume fluidly connected to the outlet by the filtration element. The filter housing comprises a main filter housing 10 and a housing cover 11. The housing cover 11 comprises an outer liner structure 110 for the filter element 2 having a longitudinal axis and projecting from the housing cover 11 into the internal cavity. The outer liner structure 110 receives the filter element 2. The outer liner structure 110 comprises a proximal end at the housing cover 11 and an opposed distal end 112 defined by a rim 112a, and comprises two cavities 111 at its distal end, adapted and arranged for receiving the respective composite structures 21, 221 embodied by the two radial seal extensions 221 and associated reinforcement structures 21. The cavities 111 both extend radially outward from the distal end of the outer liner structure 110 and are provided at diametrically opposed sides of the distal end of the outer liner structure 110. Each cavity (see FIG. 2) is defined by or comprises an upper or axial end surface or wall 111b positioned flat with the distal end of the outer liner structure 110, that embodies an undercut. The cavity 111 further comprises a radially outward wall 111a and sidewalls 111c connecting the walls 111b and 111a to the distal end of the outer liner structure 110. The cavities 111 are open towards the internal volume of the outer liner structure 110 and preferably also in a direction towards the second end E2 of the filter media pack 20, i.e., towards the proximate end of the outer liner structure 110 at the cover side (the latter to simplify removal of the composite structures from the respective cavities during servicing). At the opposite side of the wall or undercut 111b, and between the opening towards the internal volume and the opening towards the second end E2 of the filter media pack 20, a pushing rib 111d is provided, which is part of the framework of the outer liner structure 110. Axial projections of the cavities 111 and of the radial sealing surface of the seal 22 do not overlap.

When providing a new filter element during servicing, filter element 2 is first installed in the outer liner structure 110 (see FIG. 2). The first end cap 24 of filter element 2 is therefore deformed by pushing each of the composite structures inwardly. The composite structures are moved below the undercut wall 111b and into cavity 111, and are released again, allowing the end cap to snap back outwardly into its original configuration. This process can, for instance, be applied to one composite structure at a time or simultaneously to both composite structures, and results in the filter element 2 being fixed into the outer liner structure 110 and thus housing cover 11. Each composite structure is thereby trapped in the axial direction between the undercut wall 111b and the pushing rib 111d.

The housing cover 11, including the filter element 2, can then be placed on the main housing 10, whereby the filter element 2 is installed in the main housing 10 as follows. The main housing 10 comprises an inner liner structure 14, which is aligned with a housing outlet 12 and projects into an internal volume of the main housing along an inner liner axis. The inner liner 14 receives filter element 2. On an inner surface of the main housing 10, adjacent to the outlet 12, a sealing surface S is provided which is adapted and arranged for sealing against the seal 22 when the filter element 2 is finally installed. It will be appreciated by the skilled person that when a force in the axial direction is applied on the cover 11 during the positioning of the cover and closing of the filter housing, portions of the cavity 111, in this case mainly the pushing rib 111d, will exert a force on the reinforcement or covering structure 21 and push the radial seal in place such that it seals against the sealing surface S, without a risk of damaging the radial seal extensions 221 of the seal 22.

Further, optionally, in combination with the presence of a pushing surface 27 or chamfered pushing surface 27 of the end cap 24 of the respective filter element 2, the cylindrical outer liner structure 110 in the region outside of the cavities 111 is preferably adapted and predetermined for pushing against the pushing surface 27 or chamfered pushing surface 27 of the end cap 24 of the respective filter element 2, to push the seal 22 into place in the region outside of the cavities 11 and/or to provide a seal backing of the seal in the region outside of the cavities 11 when the housing cover 11 is closed.

In combination with the presence of a chamfered pushing surface 27, the inner surface of the outer liner structure 110 preferably comprises one or more complementary chamfered surfaces (for instance, a single complementary circumferential chamfered surface, interrupted in the regions of the composite structures) that is adapted and arranged for exerting pressure on the chamfered pushing surface 27.

The pushing surface 27 can, for instance, also comprise a circumferential groove opening towards the second end E2 of the filtration media pack 20 for receiving the distal end of the outer liner structure 110 in the region outside the composite structures or radial seal extensions 221.

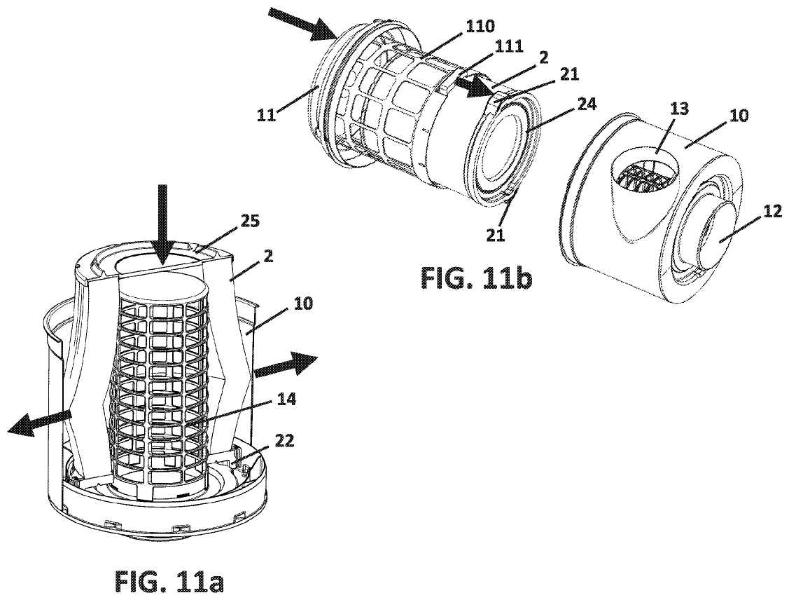

The above filter assembly 1 and installation process of the associated filter element 2, comprising installing the filter element 2 first in the housing cover 11 which comprises an outer filter liner 110 as described, before closing the cover and thereby installing the filter element, has the advantage that no force, especially no axial force, is applied on the (e.g., flexible) filter element 2 itself, which could deform or damage the filtration media pack 20 rather than allowing the exertion of enough force to bring the radial seal 22 into final sealing position. Instead, the axial force applied on the filter cover 11 is passed via the outer liner structure 110 (liners, both inner and outer, typically comprise a rigid material such as, for instance, a hard plastic material) directly onto the composite structures having a hard plastic reinforcement structure or shell 21. The plastic reinforcement structures 21 protect the polyurethane radial seal extensions 221 from being cut or damaged during that process. This is illustrated in FIGS. 11a and 11b.

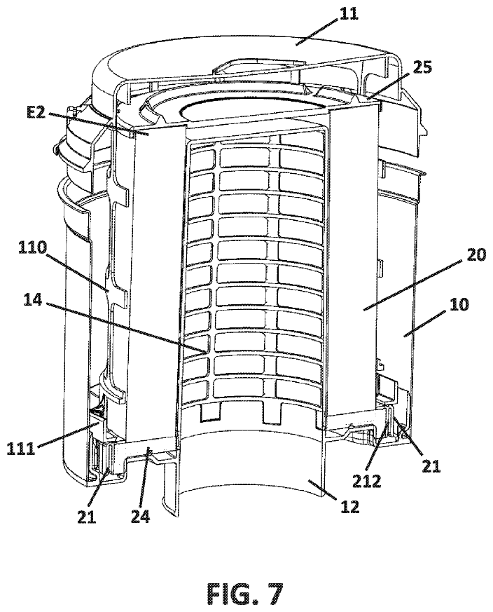

FIG. 7 illustrates the advantage that a wrong filter element, for instance, a filter element 2 with an end cap which cannot be at least partially deformed in the radial direction, would be installed first in the housing 10, as it would not be possible to install it first in the outer filter liner 110 of the housing cover 11. The housing cover 11 would obviously not be able to close the housing as the cavities 111, especially the undercut, would be blocked by the radial seal extensions 221 of the seal 22 before reaching its intended position.

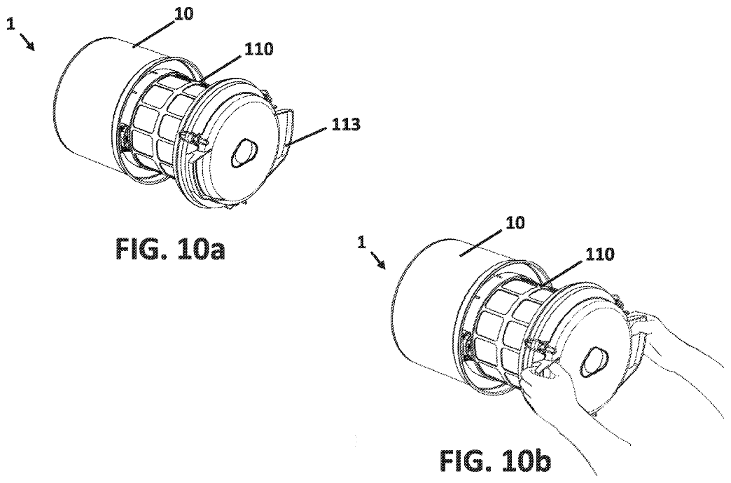

FIGS. 10a and 10b illustrate the optional feature of having one or more handles 113 on the housing cover 11 of the first preferred assembly embodiment of the present disclosure. Preferably, a pair or handles 113 are provided at radially opposite sides of the housing cover to allow an easy removal of the cover and installed filter element.

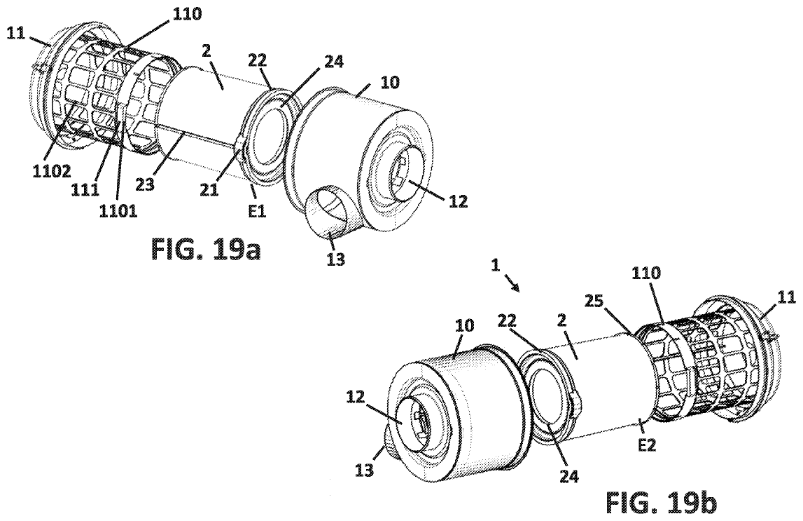

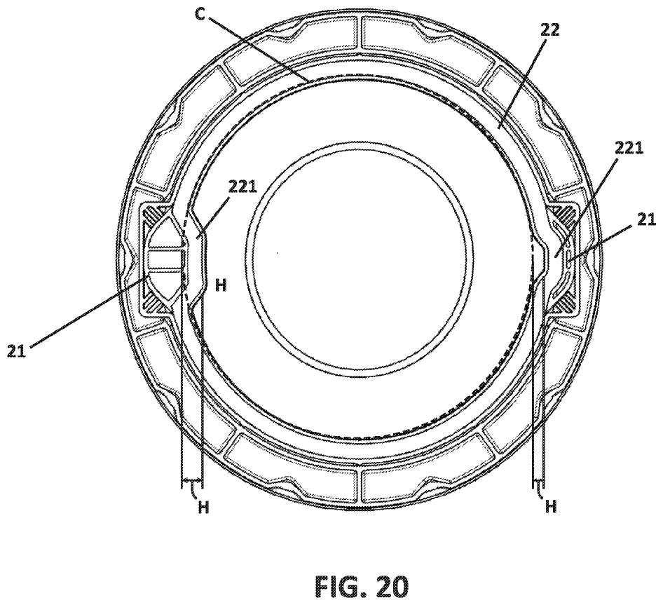

FIGS. 19a and 19b illustrate a further optional alignment feature for the filter element 2 and for the first preferred filter assembly embodiments. The filter element 2 comprises an axially extending groove 23 (for instance V- or U-shaped) in a radially outer surface of the filtration media pack 20, preferably extending from the first end E1 to the second end E2, for instance, at an angular position aligned with, for instance, centrally positioned with respect to, one of the composite structures 221, 21. The second end cap 25 also comprises a corresponding cut-out (for instance V- or U-shaped) aligned with the groove 23. In other words, the groove 23 extends though the second end cap 25. At the first end E1 of the filtration media pack 20, the groove 23 can end and abut one of the composite structures 221, 21. The outer liner structure 110 comprises a corresponding axially extending rib or guiding structure 110b arranged on an internal surface of the outer liner 110. The groove 23 receives by the rib 110b when the filter element 2 is received by the outer liner structure 110, simplifying the alignment and insertion of the filter element 2 in the housing cover 11.

### Embodiment of FIGS. 17a to 17b

FIGS. 17a and 17b are perspective views of an assembly according to a further preferred embodiment of the present disclosure. The filter element 2 differs from the filter element 2 as described in relation with the first preferred embodiment in that the radial seal extensions 221 and corresponding reinforcement or shell structures 21 are directed radially inwards. The shell structures 21 are embedded in the polyurethane first end cap 24, which is elastically deformable. The second and cap 25 and filter media pack 20 are also elastically deformable. The housing cover differs from the one described in relation to the first preferred embodiment in that the outer liner 110 comprises an undercut surface 110a that is directed radially inwardly from the inner surface of the outer liner structure 110. The seal 22 is adapted and arranged for sealing radially inwardly on a complementary sealing surface S in the housing, adjacent to the outlet opening 13. The radially outer surface 215 of the radial seal extensions 221 is backed by the respective shell structures 21. The housing can further be adapted and arranged such that the distal end of the outer liner structure 110 provides a backing for the complementary portions of the seal 22 when the cover 11 is correctly installed on the main housing 10. The undercut portions 110a are designed and arranged such that they provide backing to the composite structures 221, 21. When installing the filter element 2 into the housing 10,11, the filter element 2 is first installed in the outer liner structure 110 of the housing cover 11. The second end cap 25 of the filter element 2 is inserted first until the first end cap 24 reaches the undercut 110a, by first deforming the filer element 2. Then the first end cap 24 is deformed by pushing each of the composite structures inwardly. The composite structure is moved below the undercut 110a and released again, allowing the first end cap 24 to snap back outwardly into its original configuration. This process can, for instance, be applied to one composite structure at a time or simultaneously to both composite structures, and results in the filter element 2 being fixed into the outer liner structure 110 and thus housing cover 11.

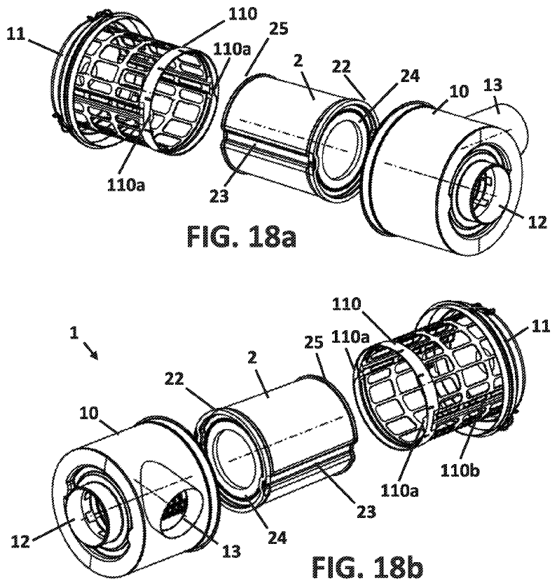

### Embodiment of FIGS. 18a to 18b

FIGS. 18a and 18b illustrate an assembly according to a further preferred embodiment of the present disclosure, which is similar to the embodiment described in relation with FIGS. 17a and 17b, but allows the filtration media pack 20 and the second end cap 25 to be non-deformable, as the filter element 2 comprises two axially extending grooves 23 (for instance, V- or U-shaped) in a radially outer surface of the filtration media pack 20, at diametrically opposed positions thereof, preferably extending from the first end E1 to the second end E2, for instance at an angular position aligned with, for instance, centrally positioned with respect to, the two composite structures 221, 21. The second end cap 25 also comprises corresponding cut-outs (for instance, V- or U-shaped) aligned with the grooves 23. In other words, the grooves 23 extend though the second end cap 25. At the first end E1 of the filtration media pack 20, the grooves 23 can end and abut one of the composite structures 221, 21. The outer liner structure 110 comprises two corresponding axially extending ribs or guiding structures 110b arranged on an internal surface of the outer liner 110, at diametrically opposed positions. The grooves 23 receive the guiding structures 110b when the filter element 2 is received by the outer liner structure 110, simplifying the alignment of the filter element 2 in the housing cover 11. Axial projections of the undercuts 110a and of the grooves 23 do not overlap, such that the undercuts 110a do not interfere with the insertion of the filter element 2 into the outer liner 110 until the moment where the composite structure reaches the undercut 110a. Then the first end cap 24 is deformed by pushing each of the composite structures inwardly. The composite structure is moved below the undercut 110a and released again, allowing the end cap to snap back outwardly into its original configuration. This process can, for instance, be applied to one composite structure at a time or simultaneously to both composite structures, and results in the filter element 2 being fixed into the outer liner structure 110 and thus housing cover 11.

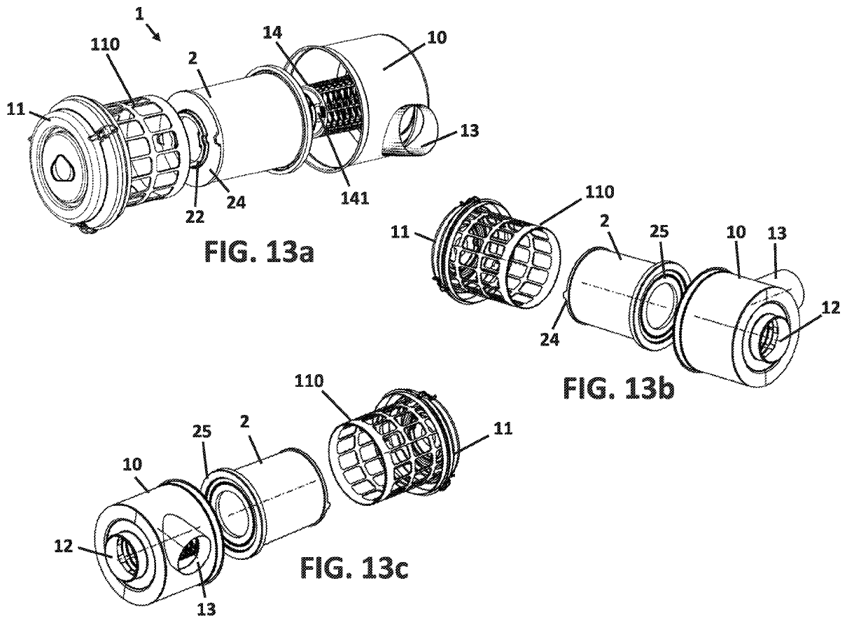

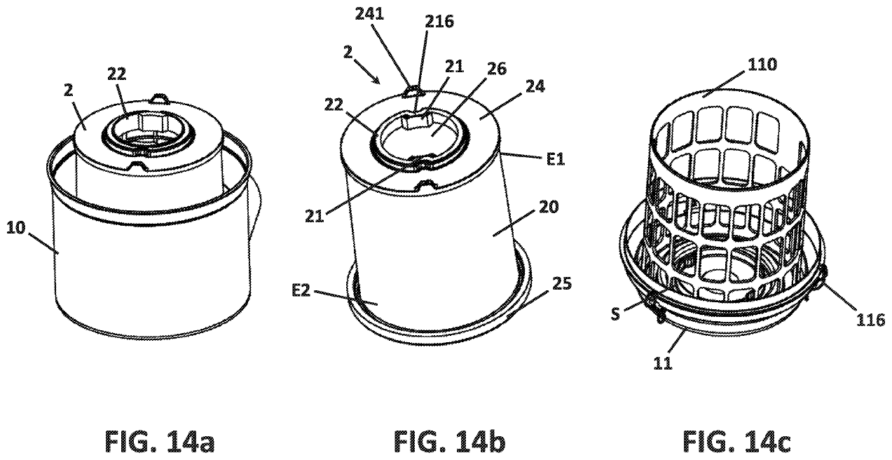

### Embodiment of FIGS. 13a to 14c

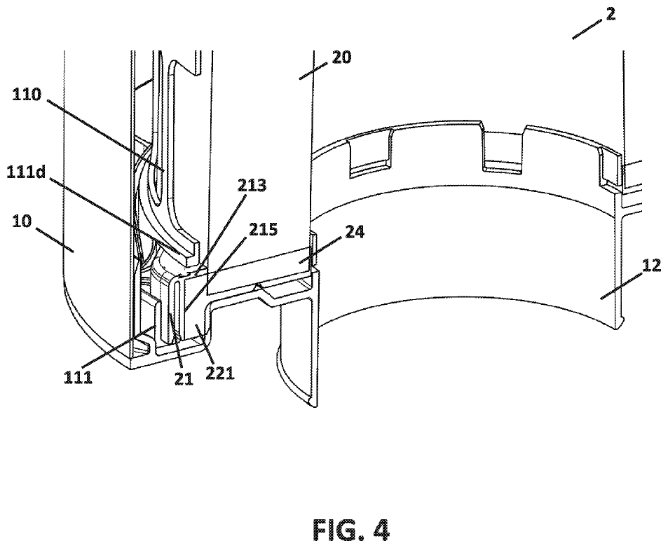

FIGS. 13a to 13c, and FIGS. 14a to 14c illustrate an assembly according to a further preferred embodiment of the present disclosure. The filter element 2 (see FIG. 4b) comprises a filtration media pack 20 comprising a longitudinal axis, a first open end cap 24 arranged at a first axial end E1 of the media pack 20 in a fluid tight manner and comprises a central opening 26. At the second axial end E2 of the filtration media pack 20, a second end cap 25 is provided in a fluid tight manner, which is also an open end cap 25. The first end cap 24 is at least partially flexible, elastically and nondestructively deformable. The first end cap 24 further comprises a generally round circumferential seal 22 surrounding the central opening 26, except for two radial seal extensions 221, which extend radially inwardly from the rest of the seal 22. It further comprises two separate reinforcement structures 21, made of hard plastic, partially embedded into the material of the first end cap 24. Each reinforcement structure 21 covers at least a portion of a corresponding radial seal extension 221, comprising a radially inner surface 216 of the radial extension 221. The first end cap further comprises two protrusions 241 that can be used as handles for pulling the composite structures out of the respective undercuts.

The circumferential seal 22 is adapted and arranged for sealing in a radially outward direction. The reinforcement structures 21 are arranged and adapted for backing the radial extensions 221 of the circumferential seal 22. The thickness of seal 22 measured in a direction perpendicular to the axial direction is constant. At the location of the two reinforcement structures 21, seal 22 thus makes respective radially inward steps. Axial projections of seal 22 and the radial outer wall of the filtration media pack 20 are concentric, except for the portions corresponding to the two radial seal extensions 221.

The composite structures comprising the radial seal extensions 221 and reinforcement structures 21 are arranged at diametrically opposed sides of the circumferential seal 22.

Each reinforcement structure 21 comprises one or more hollow cavities 212 in a second axial end surface 214 thereof, the second axial end surface 214 projecting in the same direction as the first end E1 of the filtration media pack. These hollow cavities 212 play a role in the production process as explained before.

The filtration media pack 20 comprises pleated filtration media arranged in a tubular, cylindrical manner, and is flexible. It does not comprise rigid inner or outer liners 14, 110. The end cap 24 is a potted polyurethane end cap, which is molded onto the pleated filtration media 20 and has the seal 22 integrated.

An associated filter assembly 1 comprises a filter housing 10, 11 having an inlet opening 13 and an outlet opening 12, and an internal cavity receiving the filter element 2 in a sealing manner. The filter housing comprises a main filter housing 10 and a housing cover 11, wherein the main filter housing 10 comprises an inner liner 14 for the filter element 2 having a longitudinal axis and projecting from the main housing 10 into the internal cavity. The inner liner structure 14 is received by an internal cavity of the filter element 2 during installation and comprises a proximal end at the main housing 10 and an opposed distal end. The inner liner 14 comprises two cavities or undercuts 141 at its distal end, adapted and arranged for receiving respective composite structures 21, 221 embodied by the two radial seal extensions 221 and associated reinforcement structures 21.

During installation of the filter element 2 in the housing 10, the first end cap 24 is deformed by pushing each of the composite structures outwardly, for instance, by pulling the respective protrusions 241 radially outwardly. The composite structures are moved below the undercuts (e.g., of the respective cavities 111), and are released again, allowing the end cap 24 to snap back inwardly into its original configuration. The filter element 2 is then fixed with respect to the inner liner 14 (FIG. 14a). The housing cover 11 comprises an outer liner structure 110 for the filter element 2 having a longitudinal axis and projecting from the housing cover 11 into the internal cavity. At the inner surface of the housing cover 11, radially within the outer liner structure 110, a sealing surface S is provided that is complementary to the circumferential seal 22. When the cover 11 is closed, in a position aligned with respect to the filter element 2 and inner liner 14, the seal 22 seals radially outwardly on that sealing surface S. The distal end of the inner liner structure 14 then provides a seal backing function for the seal 22. The second end cap 25 can seal at a location near the outlet 12 by means of a radial or axial seal.

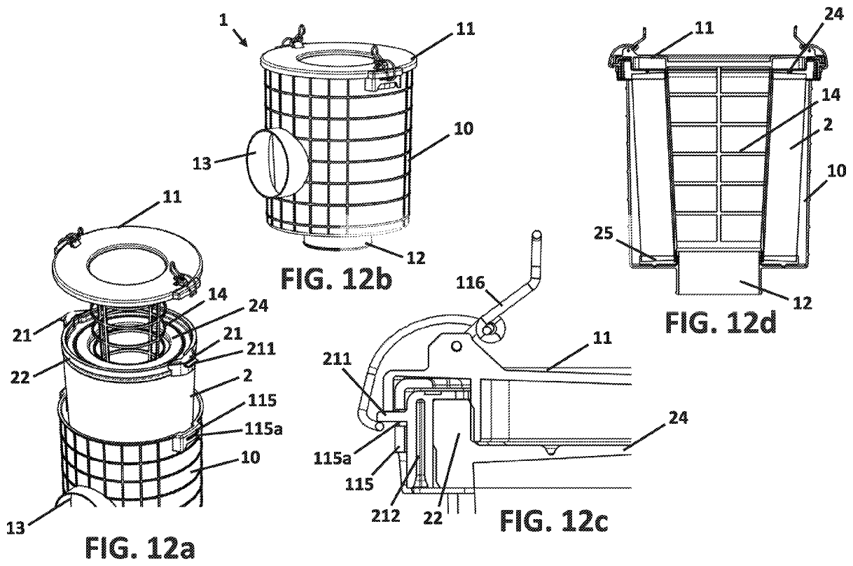

### Embodiment of FIGS. 12a to 12d

FIGS. 12a to 12d illustrate an assembly according to a further preferred embodiment of the present disclosure. The filter element 2 is similar to any of the filter elements described in relation to the first preferred embodiment described in relation to FIGS. 1a and 1b, FIG. 2 to FIG. 4, FIGS. 5a to 5c, FIGS. 6a and 6b, FIG. 7, and FIGS. 8a and 8b. The filter element 2 though further comprises hard plastic reinforcement structures 21 which comprise radially outwardly extending ribs 211. The first end cap 24 and filtration media pack 20 are elastically deformable.

The associated filter assembly comprises a filter housing 10, 11 having an inlet opening 13 and an outlet opening 12, and an internal cavity receiving a filter element in a sealing manner. Filter housing 10,11 comprises a main filter housing 10 and a housing cover 11, wherein the main filter housing 10 comprises a filter servicing opening defined by a circumferential end portion of the main filter housing 10. The housing cover comprises an inner liner 14 for the filter element 2, protruding centrally from the housing cover 11 into the internal volume. The circumferential end portion of the main housing 10 comprises two receiving cavities 115, at diametrically opposed locations, for receiving respective composite structures 221, 21 embodied by respective radial seal extensions 221 and associated reinforcement structures 21 of the filter element 2. The cavities 115 are similar to the cavities 111 for the first preferred embodiments, but are now arranged at the servicing opening (instead of at the distal end of the outer liner 110). During installation of the filter element 2 in the housing 10, the first end cap 24 is deformed by pushing each of the composite structures inwardly. Then, the composite structure is moved below the undercuts of the respective cavities 111 and released again, allowing the end cap 24 to snap back outwardly into its original configuration. Cavities 115 comprise corresponding cavity slots 115a in their radially outer wall, for receiving the radially outwardly extending ribs 211 and allowing the radially outwardly extending ribs 211 to pass through. The radially extending ribs 211 are finally exposed outside of the main housing 10. The housing cover 11 comprises latches 116 for locking the cover 11 to the main housing 10, the latches latching onto respective exposed portions of the radially outwardly extending ribs 211.

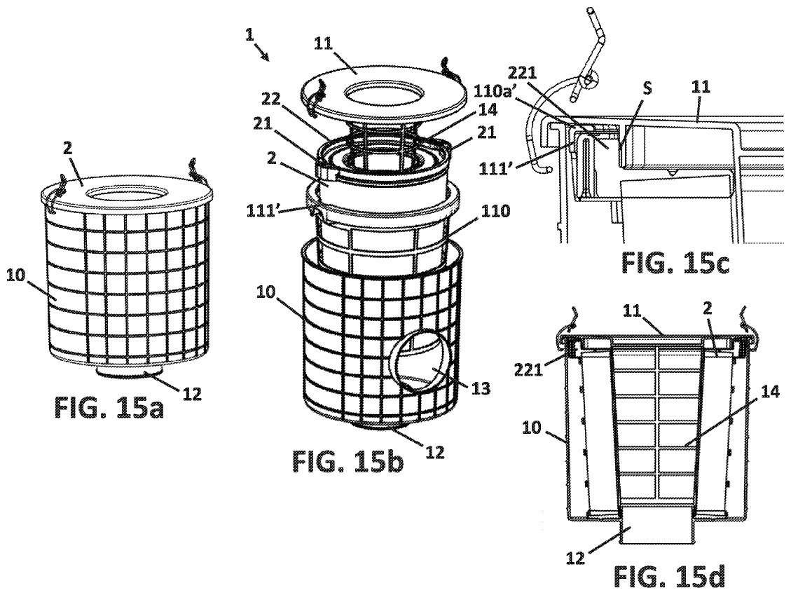

### Embodiment of FIGS. 15a to 15d

FIGS. 15a to 15d illustrate an assembly according to a further preferred embodiment of the present disclosure. The filter element 2 is similar to any of the filter elements 2 described in relation to the first preferred embodiment described in relation to FIGS. 1a and 1b, FIG. 2 to FIG. 4, FIGS. 5a to 5c), FIGS. 6a and 6b, FIG. 7, and FIGS. 8a and 8b, and has a second end cap which is open. The associated filter assembly 1 comprises a filter housing 10, 11 having an inlet opening 13 and an outlet opening 12, and an internal cavity receiving the disclosed filter element 2 in a sealing manner. The filter housing comprises a main filter housing 10 and a housing cover 11. The housing cover 11 comprises an inner liner structure 110 for the filter element 2 having a longitudinal axis and projecting from the housing cover 11 into the internal cavity. A separate and removable outer liner structure 110 is provided that is adapted for receiving the filter element 2. The separate outer liner structure 110 comprises an open first end that comprises a ring structure that is adapted for receiving the first end 24 of the filter element 2, and an axially opposed second end. The first end of the outer liner structure 110 comprises two cavities 111′, adapted and arranged for receiving the respective composite structures 21, 221 embodied by the two radial seal extensions 221 and associated reinforcement structures 21 of the filter element 2. The cavities 111′ open up radially inwardly towards a central opening of the first end of the separate outer liner structure and are provided at diametrically opposed sides of the first end of the outer liner structure 110. Each cavity 111′ (see FIGS. 15b and 15c) comprises and is at least partially defined by an undercut 110a′.

When providing a new filter element during servicing, filter element 2 is first installed in the outer liner structure 110. The first end cap 24 of filter element 2 is therefore deformed by pushing each of the composite structures inwardly. The composite structures are brought below the respective undercut 110a′ and into the respective cavity 111′, and are released again, allowing the end cap to snap back outwardly into its original configuration. This process can, for instance, be applied to one composite structure at a time or simultaneously to both composite structures, and results in the filter element 2 being fixed into the outer liner structure 110. Each composite structure is thereby trapped in the axial direction below the undercut wall 110a′ and the filter element 2 is locked into the separate outer liner structure 110. The combination of outer liner 110 and filter element 2 are then inserted into the filter housing 10, and cover 11 is provided to close the housing, at the same time introducing the inner liner 14 into filter element 2. Filter element 2 thereby forms a radial seal with a complementary sealing surface S arranged on the inside of the housing cover 11. The ring structure of the first open end of the outer liner structure 110 thereby provides a seal backing function for the radial seal 22, indirectly via the embedded reinforcement structures 21 in the regions of the radial seal extensions 221, and directly for the complementary portions/the rest of the seal 22. The second end cap 25 can seal at a location near the outlet 12 by means of a radial or axial seal.

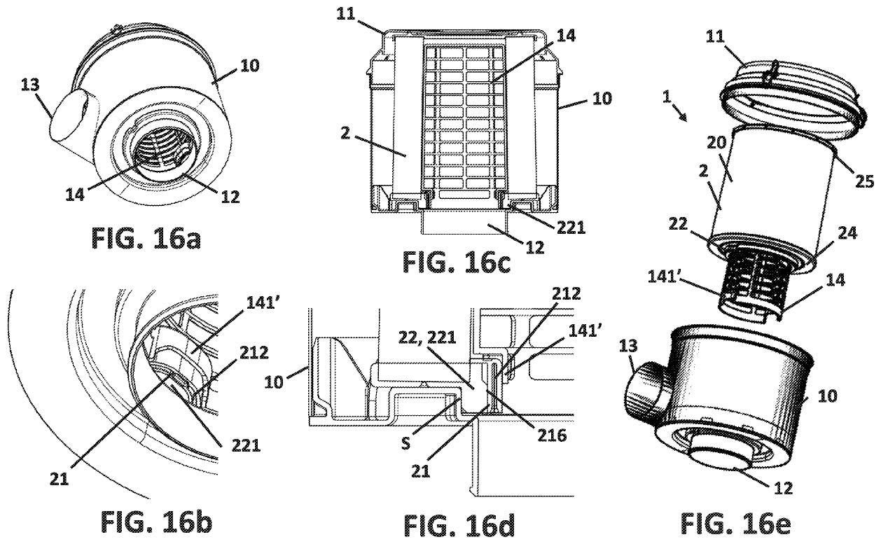

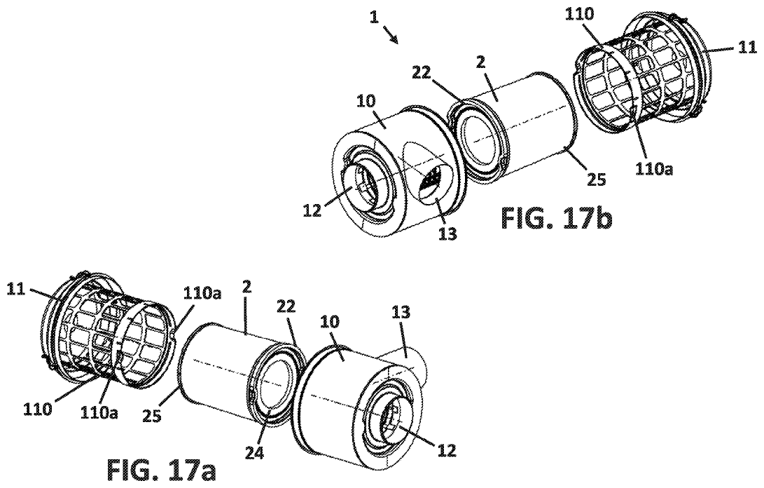

### Embodiment of FIGS. 16a to 16d

FIGS. 16a to 16d illustrate a filter element and a filter assembly according to a further preferred embodiment of the present disclosure. Filter element 2 comprises a filtration media pack 20 comprising a longitudinal axis, a first open end cap 24 arranged at a first axial end E1 of the media pack 20 in a fluid tight manner and comprises a central opening 26. At the second axial end E2 of the filtration media pack 20, a second end cap 25 is provided in a fluid tight manner, which is a closed end cap 25. The first end cap 24 is at least partially flexible, elastically and nondestructively deformable. The first end cap 24 further comprises a round circumferential seal 22 surrounding the central opening 26. Circumferential seal 22 comprises two radial seal extensions 221 extending radially inwardly from the rest of seal 22. It further comprises two separate reinforcement structures 21 partially embedded into the material of the first end cap 24. Each reinforcement or covering structure 21 covers at least a portion of a corresponding radial extension 221 of the seal 22, comprising the radially inner surface 216 of the radial extension 221.

The circumferential seal 22 is adapted and arranged for sealing in a radially outward direction. The hard plastic reinforcement structures 21 are arranged and adapted for backing the radial extension 221 of the circumferential seal 22. The thickness of seal 22 measured in a direction perpendicular to the axial direction is constant. At the location of the two reinforcement structures 21, seal 22 thus makes respective radially inward steps. Axial projections of seal 22 and the radial outer wall of the filtration media pack 20 are concentric, except for the portions corresponding to the two radial seal extensions 221.

The composite structures comprising the radial seal extensions 221 and reinforcement structures 21 are arranged at diametrically opposed sides of the circumferential seal 22.

Each reinforcement structure 21 comprises one or more hollow cavities 212 in a second axial end surface 214 thereof, the second axial end surface 214 projecting in the same direction as the first end E1 of the filtration media pack. These hollow cavities 212 play a role in the production process as explained before.

The filtration media pack 20 comprises pleated filtration media arranged in a tubular, cylindrical manner, and is flexible. It does not comprise rigid inner or outer liners 14, 110. The first end cap 24 is a potted polyurethane end cap, which is molded onto the pleated filtration media 20 and has the seal 22 integrated.

The associated filter assembly 1 comprises a separate, removable inner liner structure 14 for the filter element 2. The inner liner 14 extends axially between a first axial end and a second axial end. The filter element 2 comprises an internal volume for receiving the inner liner 14. The separate inner liner 14 comprises one or more cavities or undercuts 141′ at the first axial end. During installation of the filter element 2 in the filter housing 10, the first end cap 24 is deformed by pushing each of the composite structures outwardly. The composite structure is displaced below the respective undercut 141′ (or undercut of the cavity), and released again, allowing the end cap 24 to snap back inwardly into its original configuration. The filter element 2 and inner liner 14 are then locked to each other and can be installed together in the main filter housing 10 by positioning their first axial ends towards the outlet portion of the housing 10. Adjacent to outlet 12, the main housing 10 comprises a circumferential sealing surface S complementary to the circumferential seal 22 and adapted and arranged for providing a radially outward sealing for the radial seal 22. The first axial end of the separate, removable inner liner 14 then provides a seal backing function for the radial seal 22, indirectly via the embedded reinforcement structures 21 in the regions of the radial seal extensions 221, and directly for the complementary portions/the rest of the seal 22.

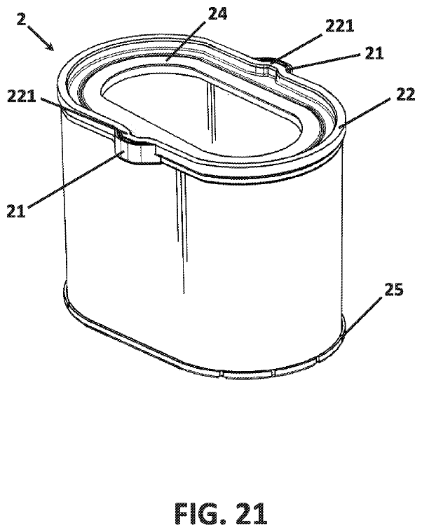

The filter elements described before were all of cylindrical shape, i.e., having a (pleated) media pack arranged in a tubular manner corresponding to a cylinder. The shape of the filter media pack is, though, not limited to cylinders but can be arranged in other shapes. Amongst others, the filter media pack 20 can, for instance, comprise an elliptical, obround, or racetrack shape. An element similar to the element of FIGS. 5a to 5c but having media arranged in an obround configuration is illustrated in FIG. 21.

### Embodiments of FIGS. 21 to 23

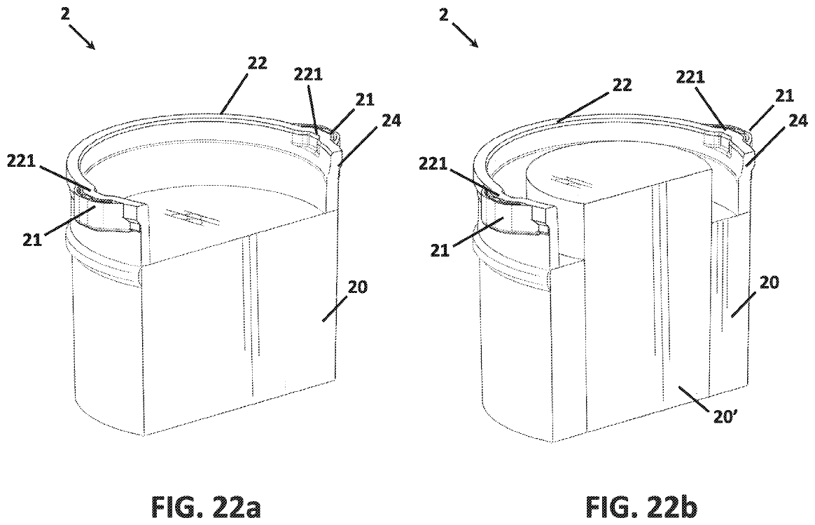

Other possible embodiments are illustrated in FIGS. 21 to 23. FIG. 22a illustrates filter element 2 comprising a media pack 20 of the fluted or z-type, having an elastically deformable first end cap 24 having two radial seal extensions 221 and corresponding embedded reinforcement structures 21. The end cap 24 comprises a polyurethane material and extends axially away from a periphery of an inflow or outflow face of the filtration media pack 20. FIG. 22b illustrates a similar filter element 2 comprising a composite fluted filtration media pack which comprises a first, centrally positioned fluted media pack 20′ having a first height and having a first set of filtration characteristics which is surrounded by a second fluted media pack 20 having a shorter height and having a different second set of filtration characteristics.

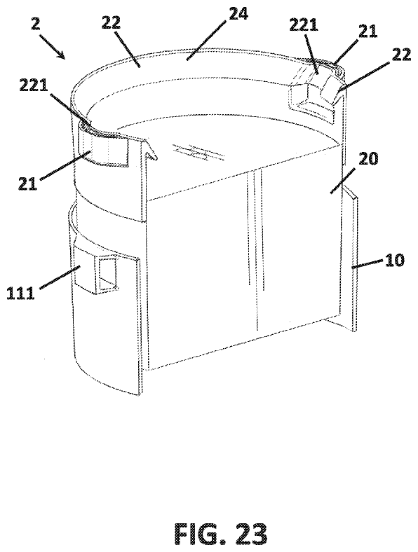

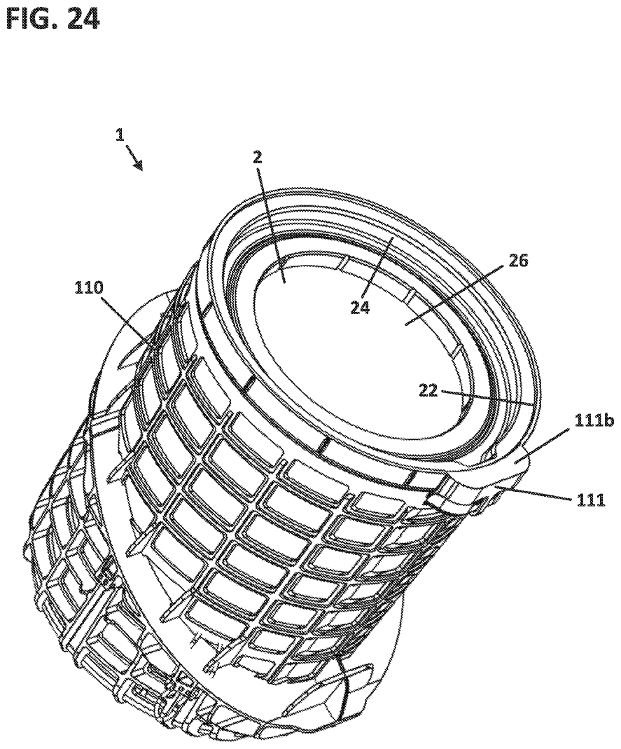

FIG. 23 illustrates a filter element 2 comprising a media pack 20 of the fluted or z-type, having an elastically deformable first end cap 24 having two radial seal extensions 221 and corresponding embedded reinforcement structures 21. The end cap 24 comprises a thermoplastic elastomer (TPE) material and extends axially away from a periphery of an inflow or outflow face of the filtration media pack 20. The seal 22 is embodied as an inwardly directed lip seal, which is backed by the reinforcement structures 21 in the area of the radial seal extensions.

All of the filter elements 2 described before disclose two radial seal extensions 221 and corresponding reinforcement structures 21 which are congruent, for instance having the same height (axial extent) and width (angular extent) and depth (radial extent). In another view, the axial projections of the one or more radial seal extensions 221 are congruent. Alternatives are possible. For instance, in alternative embodiments, the axial projections of two or more radial seal extensions differ in one or more of width and depth. Also, in certain embodiments, one of the radial seal extensions 221 and corresponding reinforcement structure 21 can extend radially inwardly, and another one of the radial seal extensions 221 and corresponding reinforcement structure 21 can extend radially outwardly. Further, in certain embodiments, one of the radial seal extensions 221 can extend radially inwardly, and another one radially outwardly, while both cover structures 21 extend radially outwardly (depicted in FIG. 20). FIG. 20 also illustrates the definition of height H of the step of the radial seal extensions and related virtual contour C (dotted line) of a virtual non radially extended seal 22.

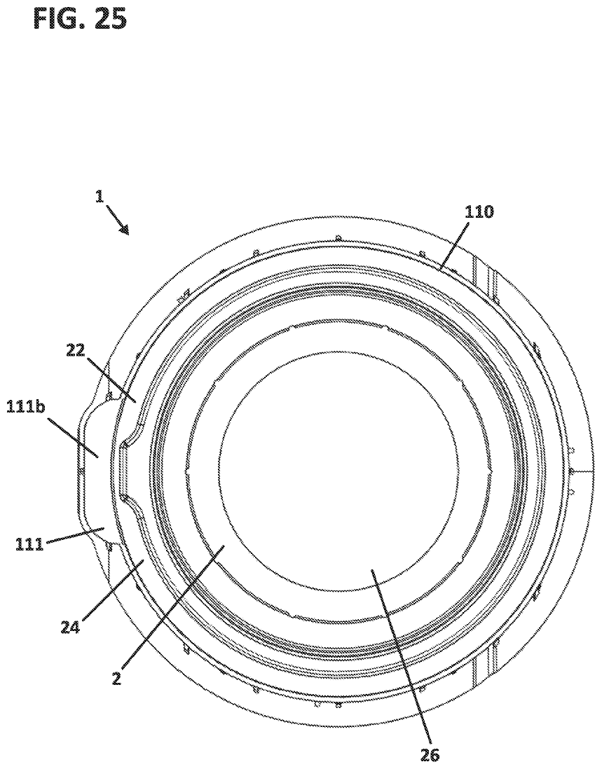

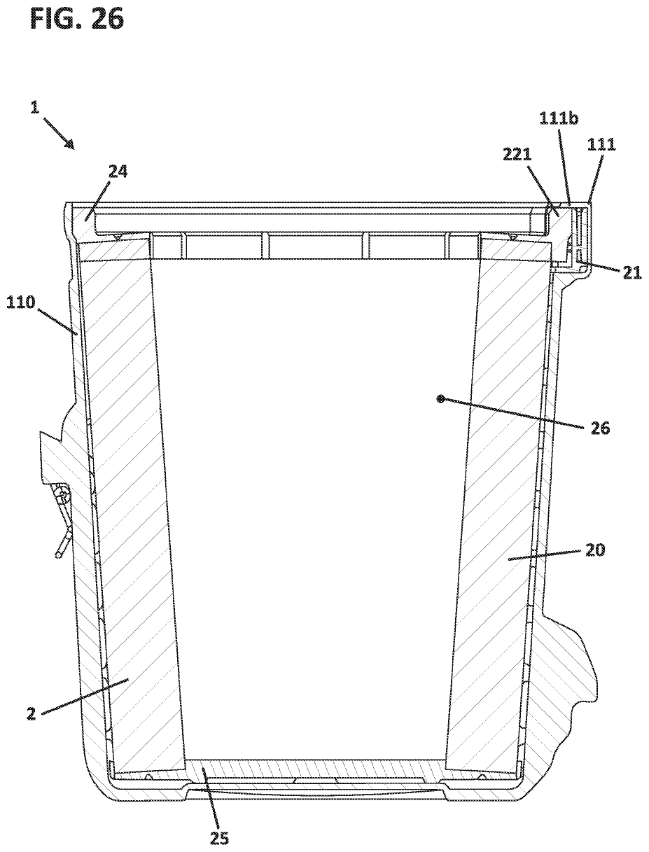

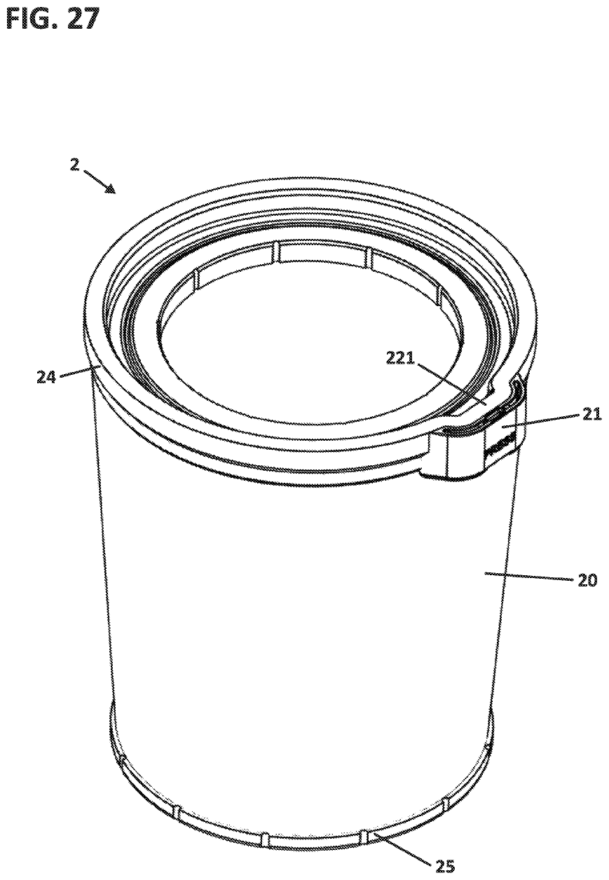

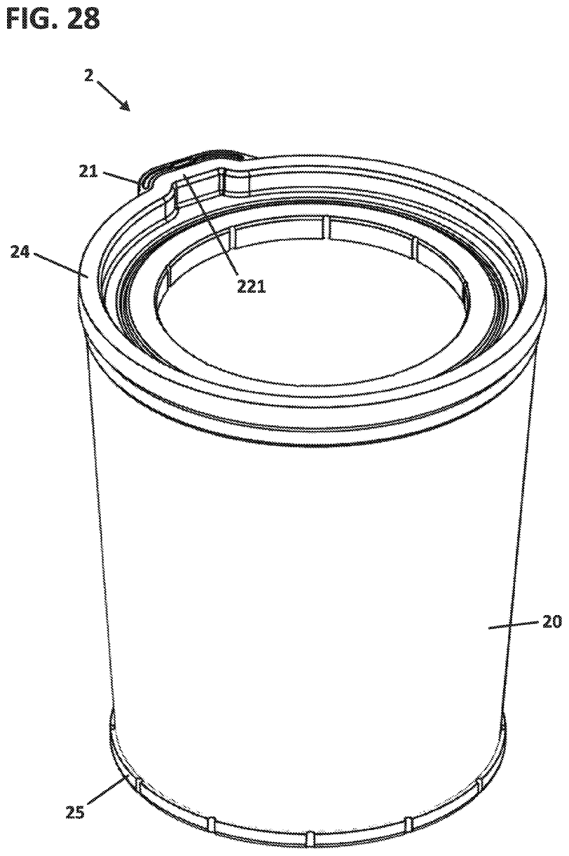

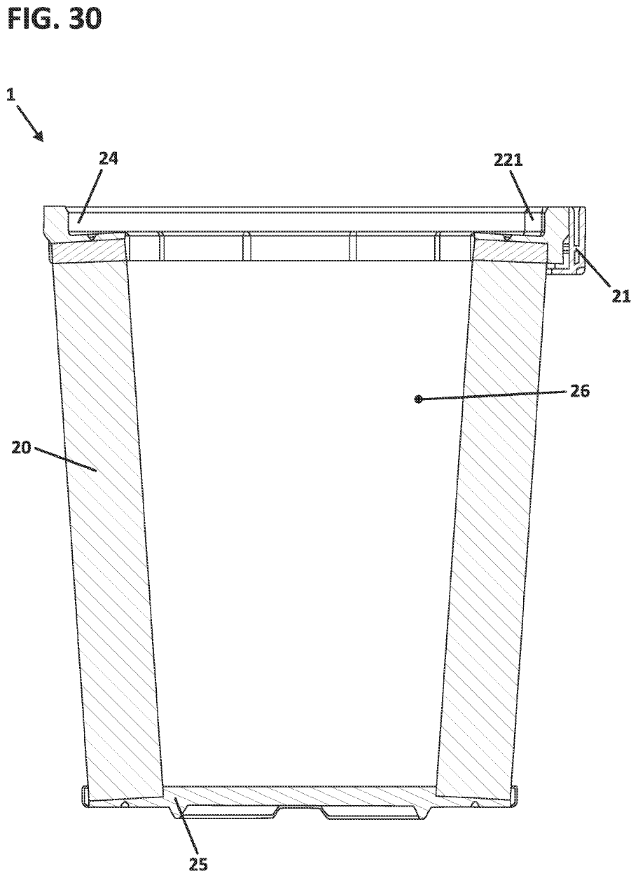

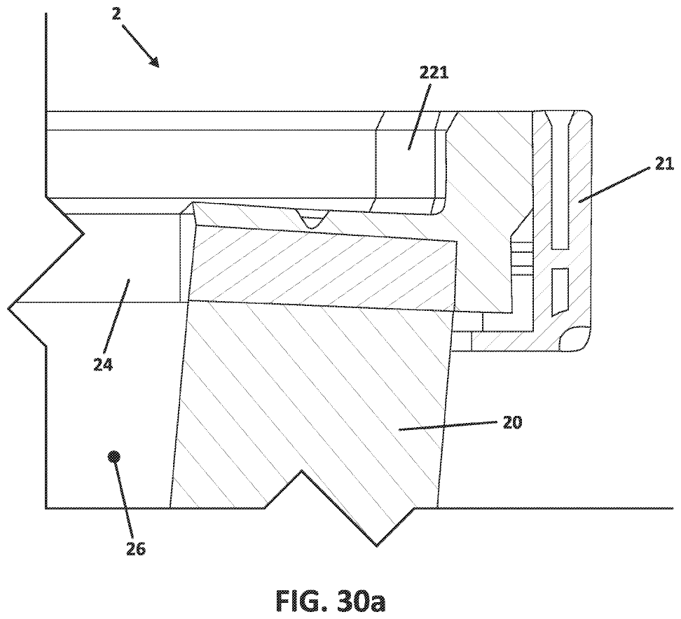

### Embodiment of FIGS. 24 to 30a

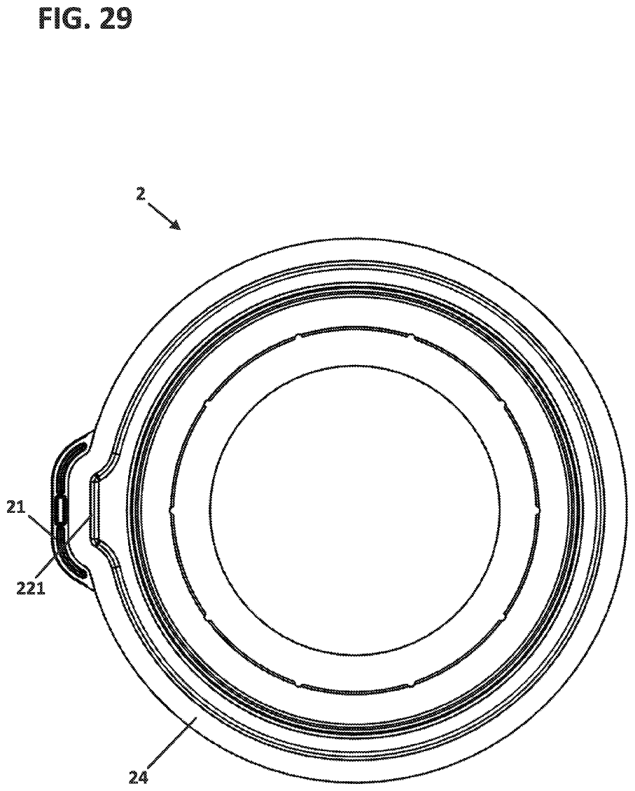

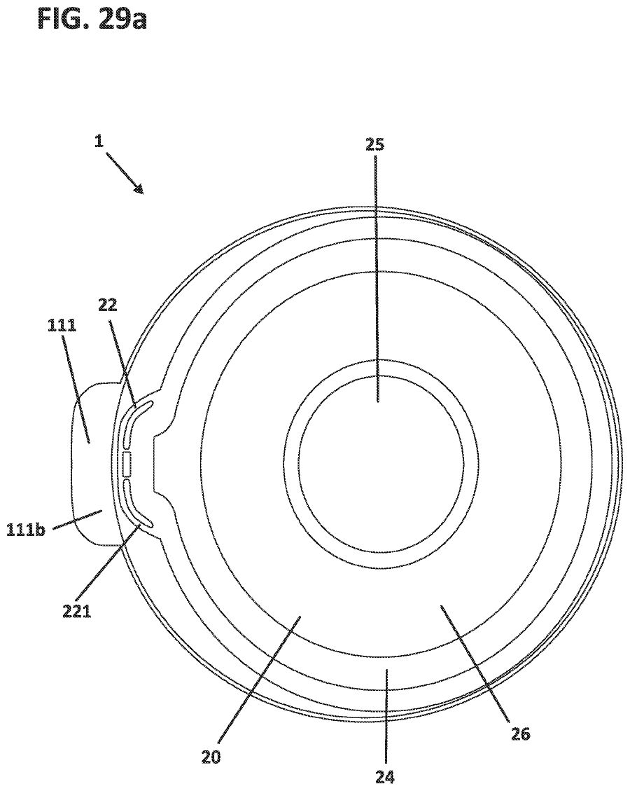

Referring to FIGS. 24-30a, a further example of a filter assembly 1 including a filter cartridge 2 is presented. The filter assembly 1 presented in FIGS. 24 to 30a is generally the same as filter assembly 1 associated with FIGS. 1a, 1(b), and others, and the previous description provided for the first example presented herein is also applicable for this example. Accordingly, like reference numbers are used and the description need not be repeated in this section. This section will instead outline differences over the filter assembly 1 associated with FIGS. 1a, 1b, and others. One notable difference is that the open end cap 24 of filter element 2 is provided with only a single reinforcement structure 21 and radial seal extension 221 rather than having two such elements. With such a configuration, the open end cap 24 can be said to have single-fold rotational symmetry. Similarly, the outer liner 110 is only provided with a single corresponding cavity 111 for receiving the reinforcement structure 21, as is illustrated in an installed condition in FIG. 29. In the example shown, portions of the reinforcement structure 21 are embedded within the material of the end cap 24. FIG. 29 shows a similar top view wherein the open end cap 24 and media 20 are compressed radially inward at the location of the reinforcement structure 21 such that the reinforcement structure 21 can be displaced past the top wall 111b defining cavity 111. It is noted that, in the position shown in FIG. 29a, the outer perimeter of the open end cap 24 is constrained by the outer liner 110. To account for this condition, the open end cap 24 is structured with sufficient flexibility and elastic properties such that the required radially inward force placed on the reinforcement structure 21 only causes a local inward deflection of the end cap 24 at the location of the radial seal extension without requiring a corresponding outward expansion of the end cap at any other location. In one characterization, this deformation can be said to create a flattened side of the end cap 24 and filter element 2. When this force is removed, the end cap 24 is sufficiently elastic to return to its natural shape, as shown in FIG. 29. With the disclosed arrangement, the filter element 2 and end cap 24 can be said to have a first shape corresponding to the natural, undeformed shape shown in FIG. 29 and to have a second shape, different from the first shape, corresponding to the deformed shape shown in FIG. 29a.

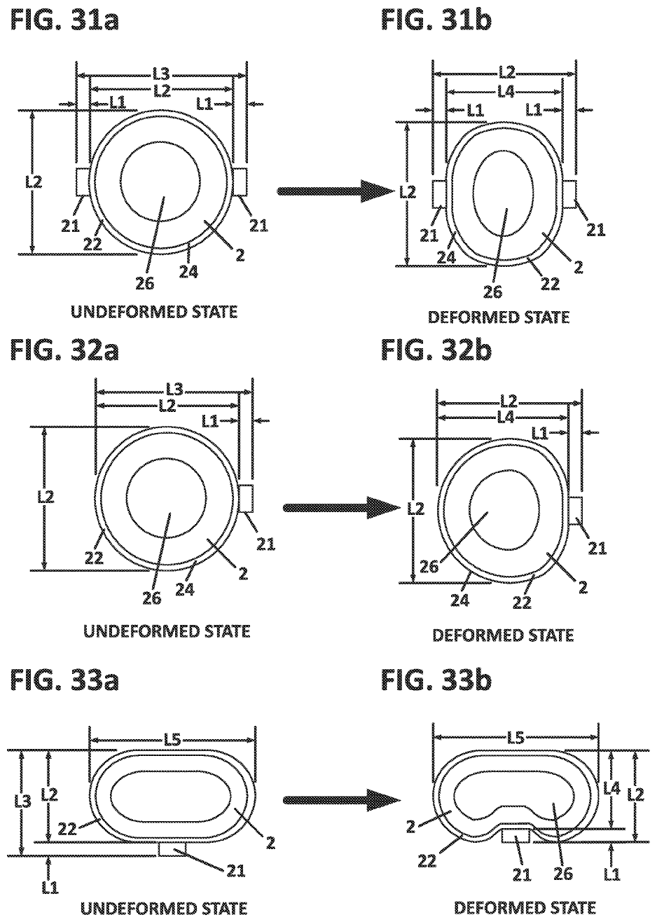

### Elastic Deformation of the Disclosed Air Filters—FIGS. 31a to FIGS. 33b

Referring to FIGS. 31a to 33b, aspects relating to elastic deformation of the above-disclosed filter elements 2 are schematically illustrated. In the below description, a number of different shapes of the filter element 2 and open end cap 24 are described. These references are directed to a ‘general’ shape meaning that the referenced shape is an overall shape notwithstanding variations due to the presence of the reinforcing structure(s) 21 and radial seal extension(s) 221. FIG. 31a shows a schematic illustration of a top view of the filter elements generally shown in FIGS. 1a to 23 in which two reinforcing structures 21 are provided. With reference to FIG. 31a, which shows the filter element in the relaxed or undeformed state, the filter element 2 has an overall dimension L3 that is the sum of a dimension L1 of two reinforcing structures 21 and a general dimension L2 of the end cap 24. In the relaxed or undeformed state shown in FIG. 31a, the filter element 2 and end cap 24 can be said to have a generally circular shape. In order to clear the inner edges of the walls 111b defining the cavities 111, the reinforcing structures 21 must be moved towards each other such that the overall dimension of the end cap 24 is deformed to have the dimension L2, thereby reducing the corresponding general dimension of the end cap to a dimension LA. Such a deformation is shown in FIG. 31b in which the filter element 2 and end cap 24 can be said to have an oval or obround type shape or to have a generally circular shape with two flattened sides. In some examples, the percent difference between L2 and L3 is about 10%. In some examples, this difference can be up to 30% depending upon the configuration of the end cap 24. Due to the end cap 24 being constrained by the housing 110, the resulting inward deflection of the end cap 24 at the location of the reinforcing structures 21 occurs such that no other portion of the end cap 24 has a dimension greater than L2. Stated another way, in the deformed state shown in FIG. 31b, no portion of the end cap 24 has a dimension that exceeds a corresponding inner dimension defined by the housing 110. With such a configuration, and as noted above, the end cap 24 can be characterized as being locally flexible or deformable, meaning that the end cap sufficiently flexible or deformable to be deflected inwardly in one location without requiring outward deflection of the end cap at any other location. This is advantageous when the end cap is radially constrained by the housing or outer liner and is prevented from expanding in a direction orthogonal to the radially applied force.

Referring to FIGS. 32a and 32b, a similar dynamic is shown, but in which the filter element 2 is provided with only one reinforcement structure 21. Such a configuration is shown in FIGS. 24 to 30(a) and described previously. As only one reinforcement structure 21 is provided in the example in FIGS. 32a and 32b, about only half of the overall inward deflection shown in FIG. 31b is required in order for the reinforcement structure 21 to pass by the wall 111b. As such, the percent difference between L 2 and L3 in such an example is about 5%. In some examples, this difference can be up to 30% depending upon the configuration of the end cap 24. The shape of the filter element 2 and end cap 24 in FIG. 32b can be said to be generally circular with a single flattened side or to have an oval shape.

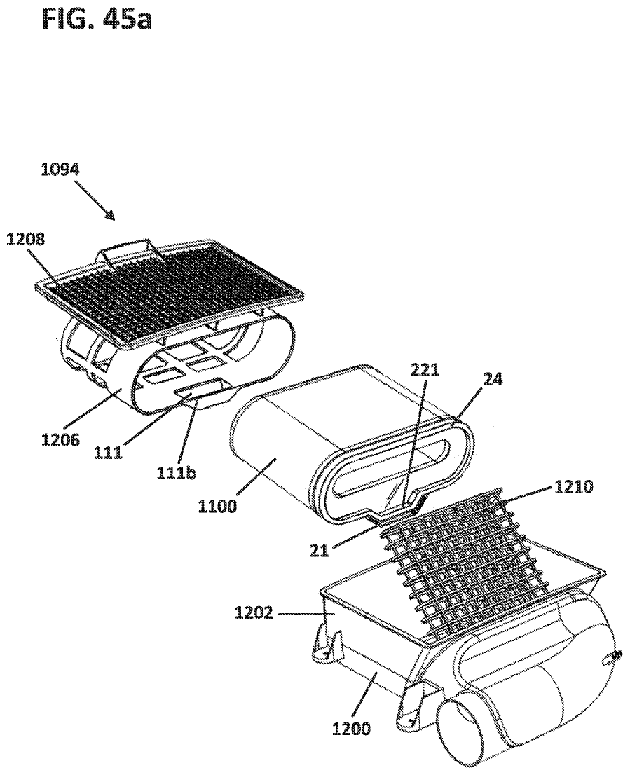

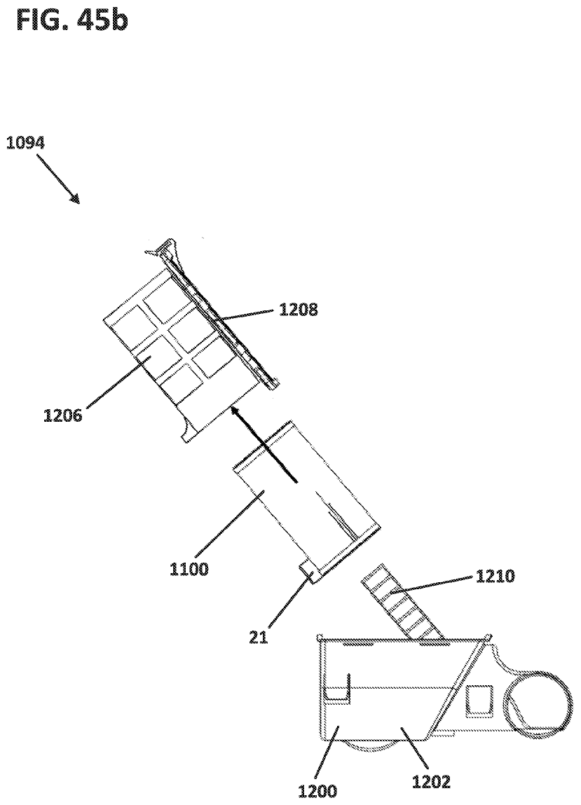

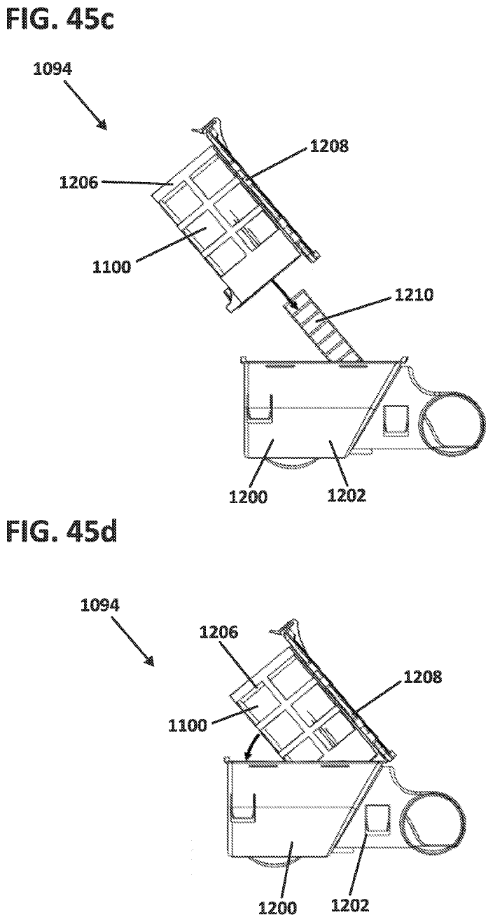

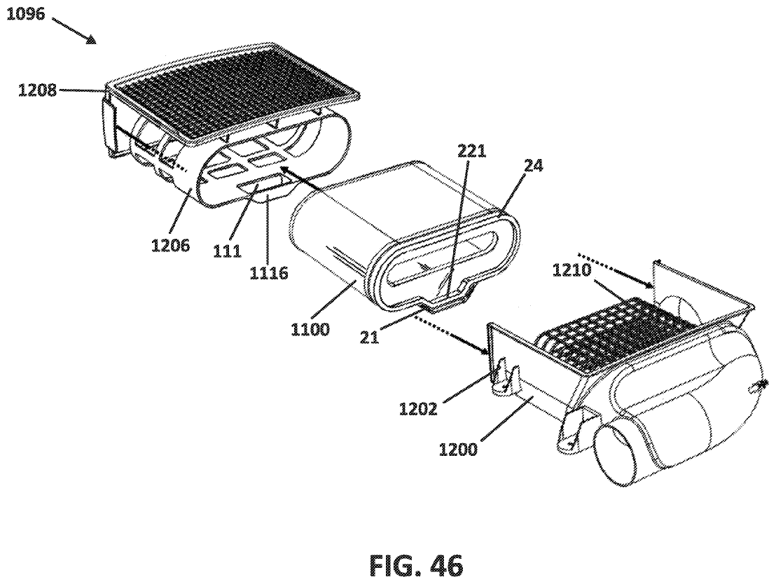

Referring to FIGS. 33a and 33b, another example is shown in which only one reinforcement structure 21 is provided. In this example, an oval or racetrack shaped filter element 2 is provided having a long side general dimension L5 and a short side general dimension LA and an overall short side dimension L3, which is the sum of dimensions L2 and L1. FIGS. 45a to 46, discussed below, are representative of such an example. As with the previous example, deformation of the end cap 24 occurs such that overall dimension L3 reduces to dimension L2. The shape of the filter element 2 and end cap 24 in FIG. 33b can be said to be generally oval or racetrack shaped with an inwardly displaced side. As with FIGS. 31a and 31b, it is also possible to provide a filter element having a racetrack or oval shape with a reinforcement structure 21 on each long side rather than a single side.

### Other Examples

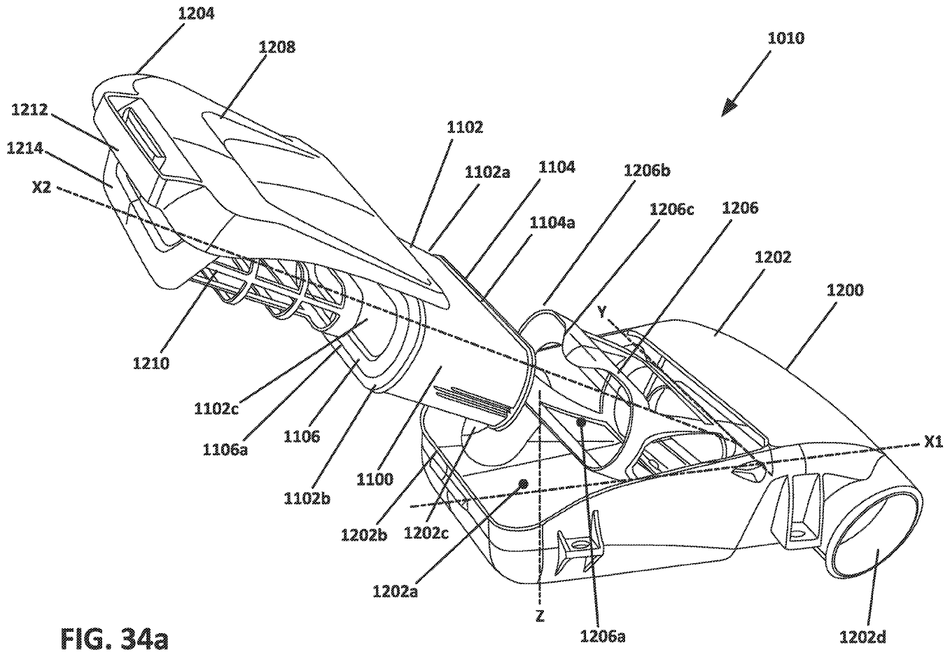

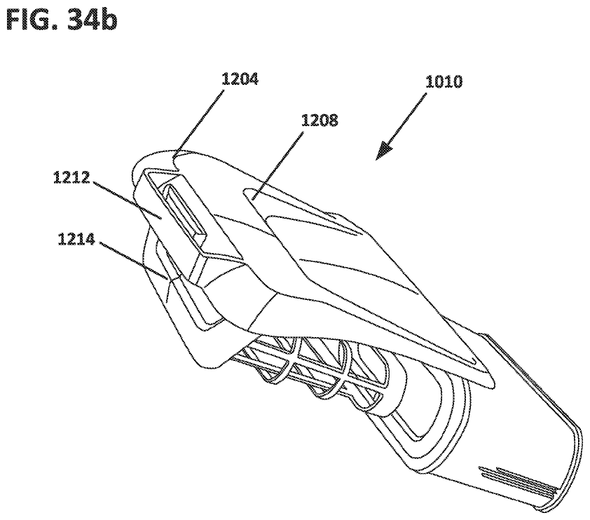

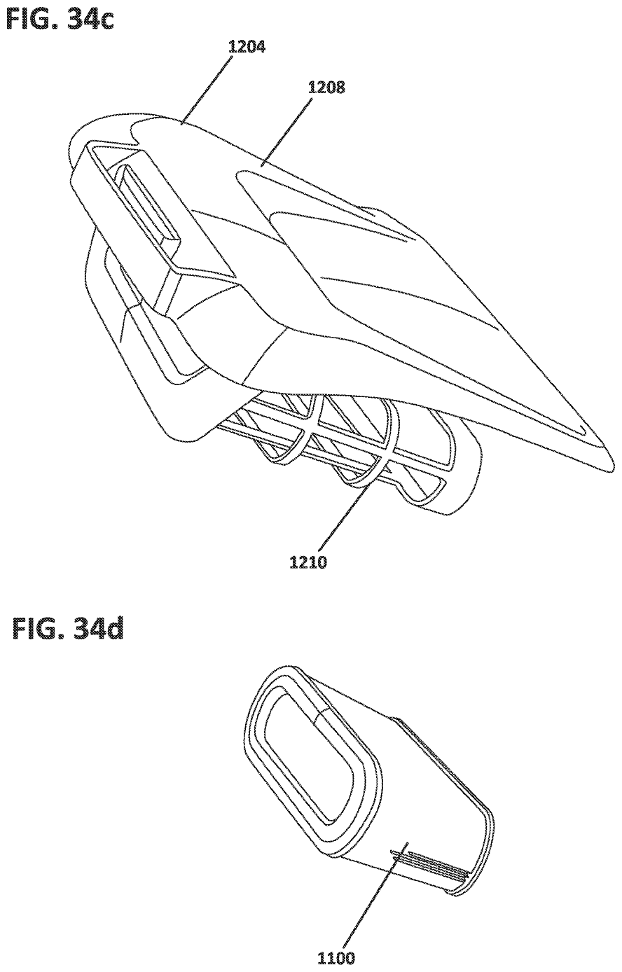

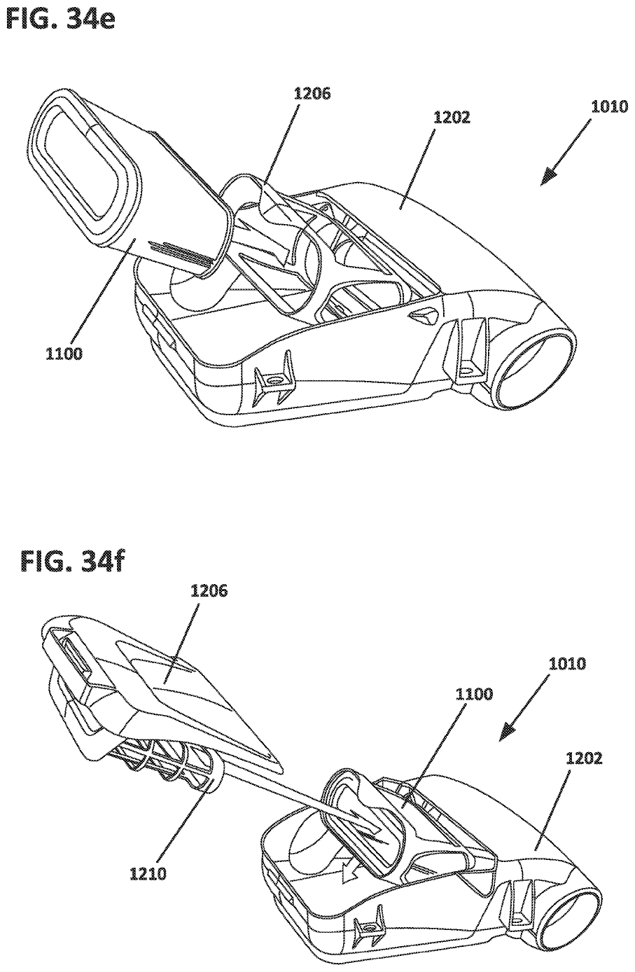

FIGS. 34a to 46 present further air cleaner assembly examples including an air filter element 1100 that can be provided without an internal and/or external support liner.

In some of the examples shown, the air filter element includes one or more reinforcement structures 21 and radial seal extensions 221 while others are shown without such features. However, it is to be understood that any of the disclosed air filter elements 1100 may be provided with one or more reinforcement structures 21 and radial seal extensions 221 in the manner described above. Further, the features of any of the above-described filter elements 2 described above may be provided on the air filter elements 1100 described below, and vice-versa. It is also noted that although the below-described air filter elements 1100 are provided with an obround or racetrack shape, that they may be provided instead with a cross-sectional shape. In the same manner, the above-described circular shaped air filter elements 2 may be provided with an obround or racetrack shape. Similarly, the air cleaner housings 1200 described below in association with FIGS. 34a to 46 may be alternately configured to accept a circular shaped air filter element, while the filter housings 10 described above may be alternately configured to accept an obround or racetrack shaped air filter element.

### Air Cleaner Assembly 1010—FIGS. 34a to 34f

FIGS. 34a to 34f illustrate a further example of the present disclosure in a schematic manner. As shown, an air cleaner 1010 is presented including a media pack 1100 installable within a housing assembly 1200.

In one aspect, the housing assembly 1200 includes a main housing 1202 defining an interior volume 1202a extending along a longitudinal axis X1 and a service opening 1202b generally facing orthogonally along an axis Z that is orthogonal to the longitudinal axis X1. Accordingly, the media pack 1100 can be inserted through the service opening 1202b and installed within the interior volume 1202a of the main housing 1202. Such a configuration may be referred to as a side-loaded configuration as the insertion and removal direction of the media pack 1100 is generally orthogonal to the longitudinal axis of the housing and to a direction of airflow through at least a portion of the housing assembly 1200. In one aspect, the main housing 1202 is shaped such that the service opening 1202b is enlarged at one end to aid easier installation and removal of the media pack 1100 from the main housing 1202. The housing assembly 1200 is further shown as including a cover assembly 1204 installable onto the main housing 1202 to cover the service opening and enclose the interior volume 1202a. In one aspect, the main housing 1202 further defines an air inlet 1202c and an air outlet 1202d.

The housing assembly 1200 is further shown as including an outer support structure 1206 having an interior region 1206a for receiving the media pack 1100 via an open end 1206b. In one aspect, the outer support structure 1206 defines a sufficient number of openings or perforations to allow air to flow through the media 1102 without undue obstruction. As discussed below, the media pack 1100 is provided without an external support. Accordingly, the outer support structure 1206 provides external support for the media pack 1100. In conjunction with the cover assembly 1204, the outer support structure 1206 securely holds the media pack 1100 within the main housing 1202. In one aspect, the outer support structure 1206 is pivotally connected to the main housing 1202 and movable between a service position (as shown in FIG. 34a) and an installed position about a pivot axis Y that is orthogonal to the general longitudinal axis X1 of the air cleaner 1010. In the example shown, the outer support structure 1206 is connected to the main housing 1202 via a snap-fit connection with predefined indexed rotational positions for ease of service. The outer support structure 1206 may also be biased, for example by a spring element, towards the service position such that the outer support structure 1206 automatically rotates into the service position when the cover assembly 1204 is removed. In the service position, a portion of the outer support structure 1206 extends through the service opening 1202b and out of the interior volume 1202a. In this position, a longitudinal axis X2 of the outer support structure 1206 is disposed at an oblique angle to the general longitudinal axis X1 of the main housing 1202, which is also an oblique angle to the longitudinal axis of the outer support structure 1206 when in the installed position. In this position, the media pack can be installed into or removed from the outer support structure 1206. In the installed position, the longitudinal axis X2 of the outer support structure 1206 is generally parallel to the general longitudinal axis X1 of the main housing 1202. In this position, the media pack 1100 cannot be removed from the outer support structure 1206. The outer support structure 1206 is shown as including an undercut section 1206c which extends across the open end 1206b and functions to retain the media pack within the interior region 1206a.

The cover assembly 1204 is shown including a cover part 1208 and an inner support structure 1210 extending from the cover part 1208. The inner support structure supports an interior side of filter media 1102 to ensure the media 1102 does not collapse due to a negative pressure difference across the media. Once the media pack is received into the outer support structure 1206, the inner support structure 1210 can be inserted within a central opening 1102c of the media pack 1100. In one aspect, the inner support structure 1210 defines a sufficient number of openings or perforations to allow air to flow through the media 1102 without undue obstruction. As discussed below, the media pack 1100 is provided without an internal support. Accordingly, the inner support structure provides internal support for the media pack 1100. In the disclosed example, the media pack 1100 is provided with a conical or tapered shape such that the media pack has a narrower or smaller dimension proximate an end cap 1104 in comparison to a corresponding dimension proximate an end cap 1106. This configuration enables the media pack 1100 to be inserted deeper into the outer support structure 1206 before resistance is encountered between the parts during installation. In the example shown, the outer support structure 1206 has straight sides but could be provided with a taper corresponding to the taper of the media pack 1100. In the example shown, the inner support structure 1210 is also provided with a tapered construction complementary to the taper of the media pack 1100. Once the cover assembly 1204 is mounted to the media pack 1100, and thus the outer support structure 1206, the assembled combination of the outer support structure 1206, media pack 1100, inner support structure 1210, and cover part 1208 can be rotated together from the service position to the installed position about the pivot axis Y of the outer support structure 1206. The cover assembly 1204 is further shown as being provided with a handle 1212 and a closure mechanism 1214 for securing the cover assembly 1204 to the main housing 1202, once the assembly is moved into the installed position. The closure mechanism 1214 may include snap-fit features, latching features, and/or fasteners. In the example shown in FIG. 33a, the cover part 1208, inner support structure 1210, handle 1212, and closure mechanism 1214 are integrally formed together as a single component. However, other configurations are possible. For example, the cover part 1208 can be a separately formed component while the inner support structure 1210, handle 1212, and closure mechanism 1214 are integrally formed as a second component and connectable to the cover part 1208, as shown in FIG. 33b. With such an arrangement, an operator would not be able to inadvertently close the cover part 1208 without the separate inner support structure 1210 having been installed since the closure mechanism 1214 is associated with the inner support structure 1210.

In one aspect, the media pack 1100 includes filter media 1102 extending between a first end cap 1104 and a second end cap 1106. In the particular example shown, the filter media 1102 is pleated media arranged in a tubular manner to define a central opening 1102c around an axis X. Other media types and configurations are possible, for example, fluted media, depth media, non-pleated media, coiled media, and/or stacked media, etc. A first open end cap 1104 is connected to a first axial end 1102a of the filter media pack 1100 in a fluid tight manner. A second open end cap 1106 is connected to a second axial end 1102b of the filter media pack 1100 in a fluid tight manner. The first and second end caps 1104, 1106 can, for instance, be formed and attached to the filter media pack 1100 by a polyurethane potting process. In such case, a first circumferential seal member 1104a of the first end cap 1104 and a second circumferential seal member 1106a of the second end cap 1106 can be formed during the same process. The first circumferential seal 1104a is a portion of the first end cap 1104 and is configured to form a seal with the main housing 1202 of the housing assembly 1200 while the second circumferential seal 1106a is a portion of the second end cap 1106 and is configured to form a seal with a portion of the cover assembly 1204 of the housing assembly 1200. With such an arrangement, the seal members 1104a, 1106a ensure that all air entering the interior volume 1202a via the air inlet 1202c must first pass through the filter media 1102 before exiting through the air outlet 1202d.

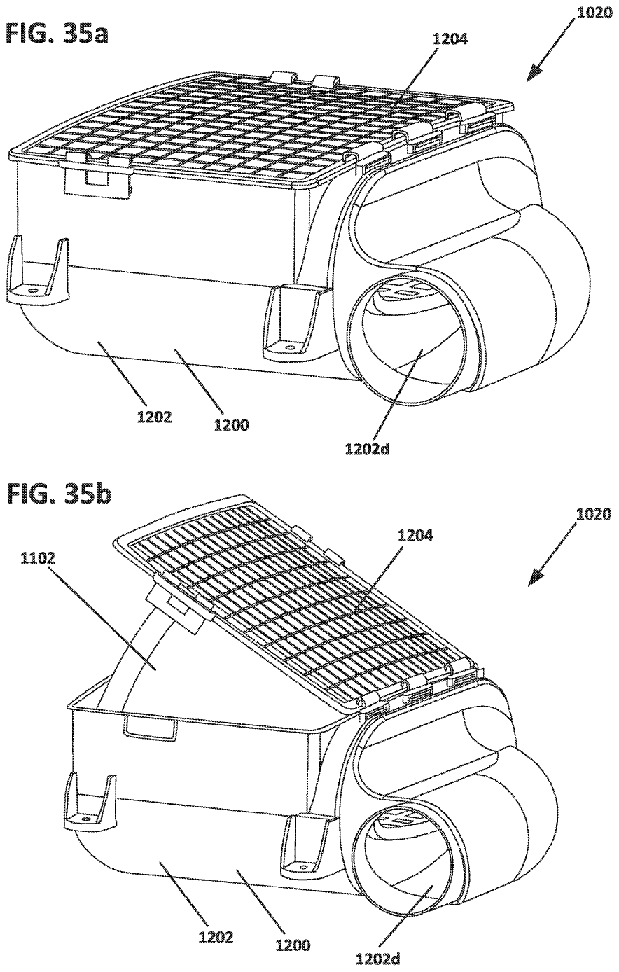

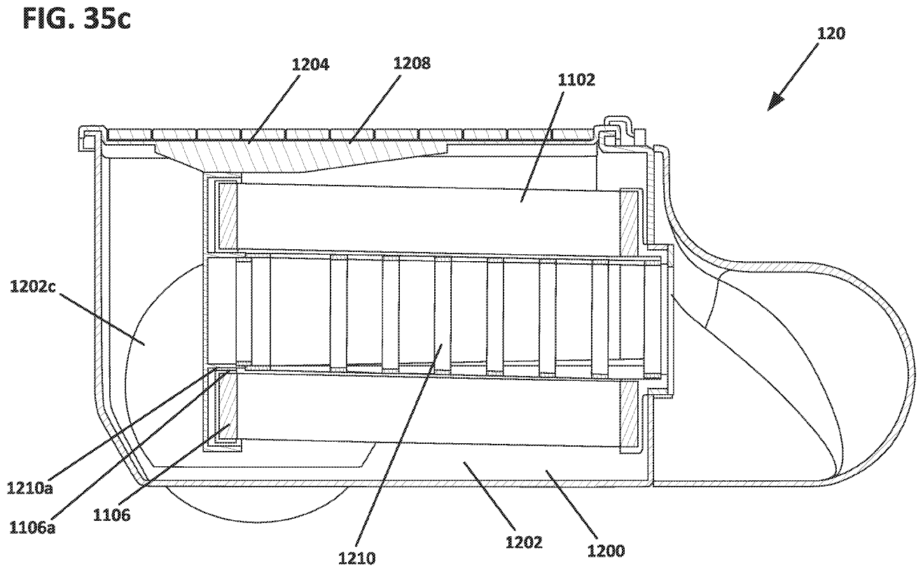

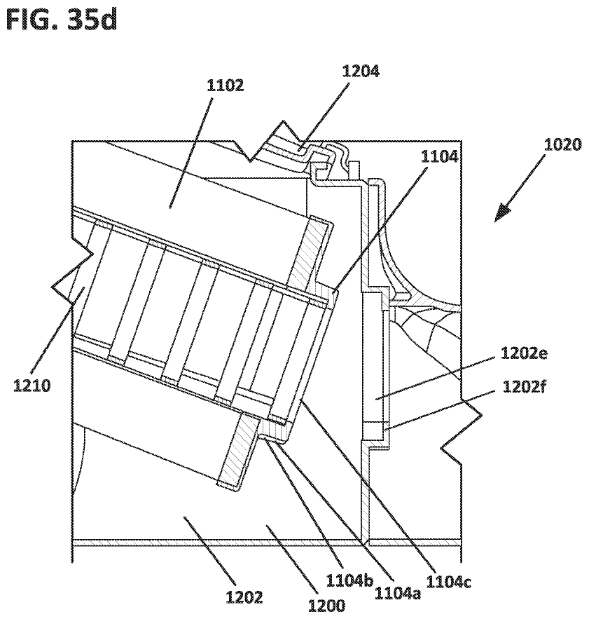

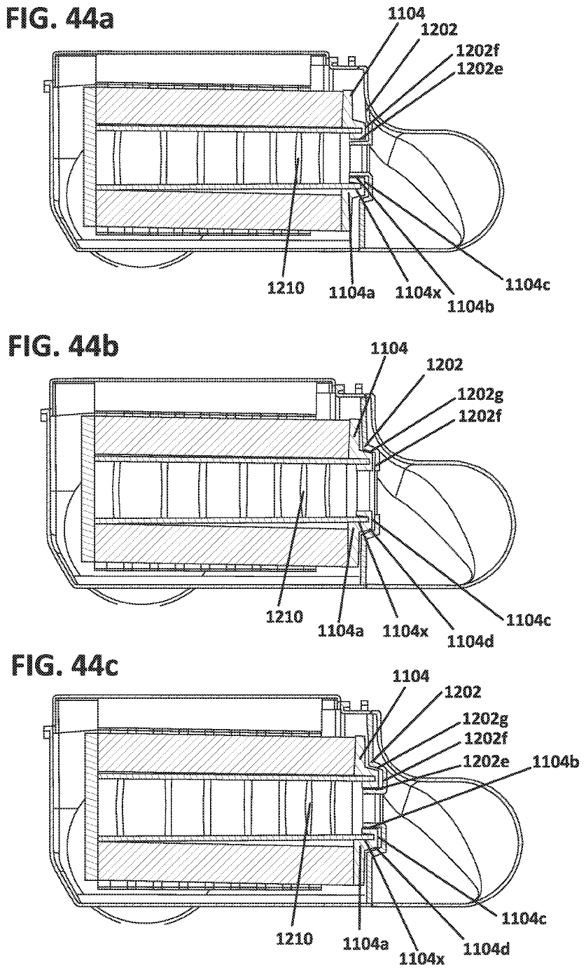

In one aspect, the first and second seal members 1104a, 1106a can be configured with one or more sealing surfaces to respectively form a seal with the main housing 1202 and cover assembly 1204, and can be configured similarly or differently. For example, one or both of the seal members 1104a, 1106a can be configured to have a surface that faces in a radially outward direction to form a seal with a radially inward facing surface of the main housing 1202/cover assembly 1204, to have a surface that faces in a radially inward direction to form a seal with a radially outward surface of the main housing 1202/cover assembly 1204, and/or to have a surface that faces in an axial direction to form a seal with an axially facing surface of the main housing 1202/cover assembly 1204. Further, the shown and described seal configurations relating to FIGS. 35c, 35d, and 44a to 44c are fully applicable to this example, and to all others where an inner support structure 1210 is provided. In one aspect, the end caps 1104, 1106, including both circumferential seal members 1104a, 1106a, are generally obround or racetrack shaped. The filter media 1102 is also shown as being provided with an obround or racetrack shape with a hollow interior. Other shapes for the end caps 1104, 1106, seal members 1104a, 1106a, and filter media 1102 are possible, for example, cylindrical, oval, and conical shapes.

As noted above, the media pack 1100 is provided without an inner support structure and is further provided without an external support structure. Providing a media pack 1100 without internal and external support structures can be advantageous in reducing cost of the media pack 1100 and in providing a more environmentally friendly media pack that results in less waste material after use. Further, providing a media pack 1100 without internal and external support structures, in combination with other features, enables the media pack 1100, including the filter media 1102 and end caps 1104, 1106, to be non-destructively deformable, e.g., elastically deformable. Accordingly, the media pack 1100 can be compressed or deformed to avoid the undercut portion 1206c of the outer support structure 1206 during installation and removal of the media pack 1100 through the opening 1206b. During installation, once the media pack 1100 is fully installed into the interior region 1206a of the outer support structure 1206 and released, the media pack 1100 will return to its normal or relaxed state such that an interference exists between the end cap 1106 and the undercut portion 1206c. In this position, the media pack 1100 is securely held within the outer support structure 1206 unless deformed by the operator. This installation step is shown in FIGS. 34e and 34f. After installation of the media pack 1100 into the outer support structure 1206, the inner support structure 1210 can be inserted into the media pack 100. Notably, the inner support structure 210, once inserted into the central opening 1102c, prevents inward deflection of the media pack 1100 and therefore ensures that the media pack 1100 is securely positioned within the housing assembly 1200 when in the installed position and ensures that the media pack 1100 cannot be removed from the outer support structure 1206 until after the cover assembly 1204 has been removed from the media pack 1100. It is also observed that, when the media pack 1100 is in the installed position and the cover assembly 1204 is closed, the cover part 1208 and support structures 1206, 1210 extend in a direction that is generally parallel to the longitudinal axis X1 and in a direction that is generally orthogonal to axis Z of the service opening.

As previously mentioned, the concepts of the present disclosure are not limited to a single configuration or to a single combination of features. For example, many further possible variations exist beyond what is shown for the example shown in FIGS. 34a to 34f. To further illustrate some of these variations, FIGS. 35a to 46 are presented and described below for air cleaner assemblies 1020, 1030, 1040, 1050, 1060, 1070, 1080, 1090, 1092, 1094, 1096. Where similarities exist, it is noted that the above-provided description for the example of FIGS. 34a to 34f is applicable to the below examples and need not be repeated below. Rather, the descriptions below will primarily focus on the primary differences among the various configurations and/or where combinations of features are different from other disclosed embodiments. It is also noted that the features described below may also be incorporated into the example shown in FIGS. 34a to 34f, and vice-versa. For example, any of the air cleaner assemblies 1020 to 1096 may be provided with a slanted cover part and main housing, as disclosed for air cleaner 1010, to provide an enlarged service opening for installation of the media pack into the housing assembly. It is also noted that for any of the configurations presented herein, the inner liner structure 1210 may be omitted in the case where media having opposite flow faces without defining an interior opening (e.g., fluted media) is used for the media pack 1100.

### Air Cleaner Assembly 1020—FIGS. 35a to 35d

FIGS. 35a to 35d illustrate an example of the present disclosure in a schematic manner. As shown, an air cleaner assembly 1020 is presented including a media pack 1100 installable within a housing assembly 1200. While the air cleaner assembly 1020 is similar to air cleaner 1010 in that the cover assembly 1204 is provided with an inner support structure 1210, the housing assembly 1200 is not provided with an outer support structure. Accordingly, the media pack 1100 in this example is not supported externally by a portion of the housing assembly 1200. In some examples, the media pack 1100 can be provided with an integrated outer liner where such support is desired or needed. In this example, the cover 1204, and thus the inner support structure 1210 are entirely removable from the main housing 1202 with the media pack 1100. Such a configuration allows an operator to fully remove the media pack 1100 and cover assembly 1204 from the main housing 1200 such that the media pack 1100 can be removed and replaced with a new media pack 1100 at a location (e.g., a work bench) separate from the vehicle. After replacement, the assembly with the new media pack 1100 can be returned and installed onto the main housing 1202. In some examples, the cover assembly 1204 can secured to the housing 1202 via latches, such as over-center latches, and optionally in combination with other mating features of the main housing 1202 and cover assembly 1204. As most easily viewed in FIG. 35c, the seal member 1106a has a first surface 1106b that faces in a radially inward direction to form a seal with a radially outward facing surface 1210a of the inner support structure 1210.

With reference to FIG. 35d, it can be seen that the seal member 1104a of the end cap 1104 has a first surface 1104b that faces in a radially outward direction to form a primary radial seal with a radially inward facing surface 1202e of the main housing 1202 and has a second surface 1104c that faces in an axial direction to form a secondary axial seal with an axial surface 1202f of the main housing 1202. FIGS. 35c and 35d also show that the inner support structure 1210 extends axially beyond the end of the filter media 1102 to within an interior area defined by the end cap 1104 and seal member 1104a. With such a configuration, the support structure 1210 backs up the seal member 1104a to limit deflection of the seal member 1104a in a radially inward direction. When the media pack 1100 is installed within the housing, this feature results in the seal member 1104a being compressed between the support structure 1210 and surface 1202e of the main housing body 1202. Accordingly, the presence of the inner support liner 1210 within the end cap 1104 aids in ensuring that the integrity of the seal between the radially outward facing surface 1104c of the seal member 1104a and radially inward facing surface 1202e of the main housing 1202 is maintained. FIGS. 44a to 44c show additional seal configurations in which the end cap 1104 defines an axially extending groove 1104x for receiving an end of the inner support structure 1210. By providing the groove 1104x, the inner support structure 1210 is able to further stabilize and support the adjacent seal member 1104a. The groove can have a u-shape, v-shape, or rectangular shape with or without rounded corners. FIG. 44A shows a seal configuration generally similar to that shown in FIGS. 35c and 35d in which the seal first surface 1104b is configured to face in a radially outward direction to form a seal with the radially inward facing surface 1202e and in which the seal surface 1104c is configured to face in an axial direction to form an axial seal with the axial facing surface 1202f of a portion of the main housing 1202. FIG. 44b shows an alternative arrangement in which a radially inward facing surface 1104d to form a seal with a radially outward facing surface 1202g of the main housing 1202. FIG. 44c shows a configuration that is essentially a combination of the sealing surfaces shown in FIGS. 44a and 44b in which the housing has sealing surfaces 1202e, 1202f, 1202g forming a seal with surfaces 1104b, 1104c, 1104d of the seal member 1104a. It is noted that the sealing configurations shown in FIGS. 35b, 35c, and 44a to 44c may be provided for any of the air cleaner assemblies provided herein in which the media pack has an inner support structure 1210 and are not limited to any particular embodiment of the disclosure. A further disclosure of potential seal configurations usable with the embodiments of this disclosure can be found within PCT International Patent Application Serial Number PCT/US 2024/015821, filed Feb. 14, 2024, the entirety of which is incorporated by reference herein.

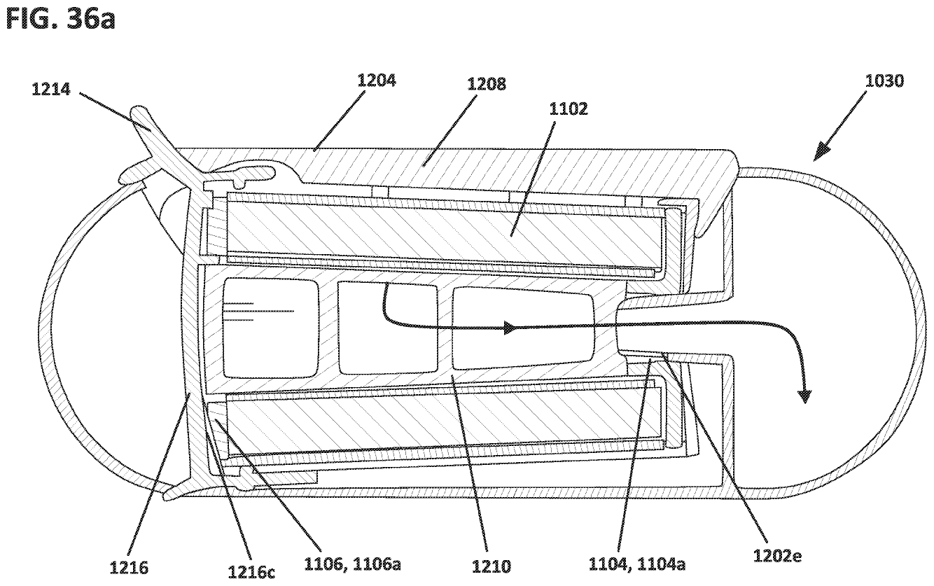

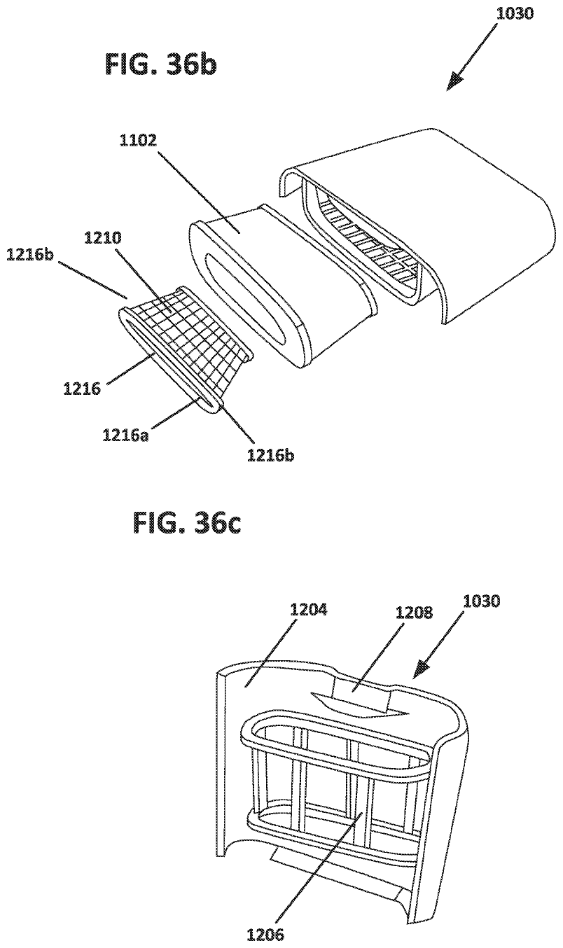

### Air Cleaner Assembly 1030—FIGS. 36a to 36c

FIGS. 36a to 36c illustrate an example of the present disclosure in a schematic manner. As shown, an air cleaner assembly 1030 is presented including a media pack 1100 installable within a housing assembly 1200. While the air cleaner assembly 1030 is similar to air cleaner assembly 1010 in that both outer and inner liner structures 1206, 1210 are provided, air cleaner assembly 1030 differs in that the outer liner structure 1206 is provided as part of the cover assembly 1204. Air cleaner assembly 1030 differs further in that the inner liner structure 1210 is provided as part of an entirely separate end structure 1216 incorporating the closure mechanism 1214, such that the cover part 1208 cannot be secured to the main housing 1202 without the end structure 1216 present. In one aspect, the end structure 1216 is provided with an end wall 1216a and latch tabs 1216b. The latch tabs 1216b are configured to secure against portions of the outer liner structure 1206 to lock or secure the media pack 1100 and end structure 1216 to the cover assembly 1204. End structure 1216 is also provided with an axially facing surface 1216c against which the seal member 1106a of the end cap 1106 can form a seal. At the opposite end of the media pack 1100, the end cap 1104 is provided with a radially inward facing seal member 1104a that forms a seal against a radially outward facing surface of the main housing 1202. As with the air cleaner 1020, the cover assembly 1204 and media pack 1100 of air cleaner 1030 can be removed from the main housing 1202 such that the media pack 1100 can be changed at a more convenient location, if desired.

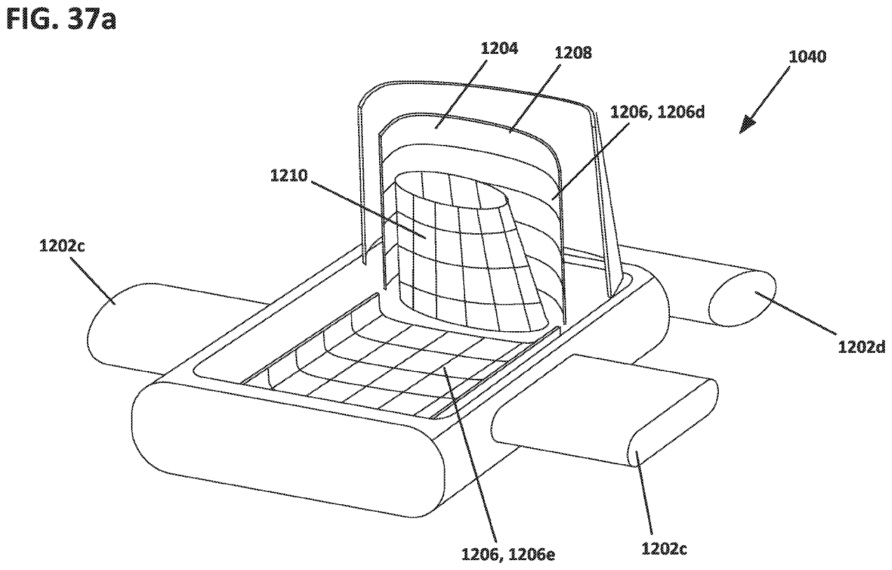

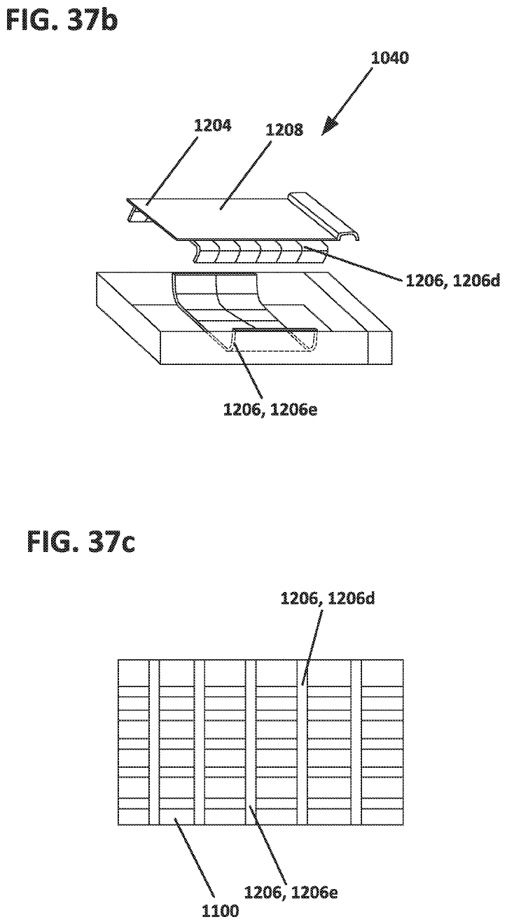

### Air Cleaner Assembly 1040—FIGS. 37a to 37c

FIGS. 37a to 37c illustrate an example of the present disclosure in a schematic manner. As shown, an air cleaner assembly 1040 is presented including a media pack 1100 installable within a housing assembly 1200. While the air cleaner assembly 1040 is similar to air cleaner assembly 1010 in that both outer and inner liner structures 1206, 1210 are provided, air cleaner assembly 1040 differs in that the outer liner structure 1206 is cooperatively defined by a first portion 1206d associated with the cover part 1208 and a second portion 1206e associated with the main housing 1202. In such a configuration, the first and second portions 1206d, 1206e act as half-shells to enclose the media pack 1100 along a joint line A. Air cleaner assembly 1040 further differs in that the inner liner structure 1210 is rotatably supported by the main housing 1202 and is movable between service and installed positions in a manner generally similar to that described for the outer liner structure 1206 of FIGS. 34a to 34f. With such a configuration, the media pack 1100 can be installed over the inner liner structure 1210 and then rotated into the installed position, after which the cover part 1208 is rotated or positioned (if not attached) to a closed position and latched to the main housing 1202. As depicted in FIGS. 37b and 37c, the outer liner structure portions 1206d, 1206e can be configured with various different lengths and locations and need not be mirror images of each other nor extend the entire length of the media pack.

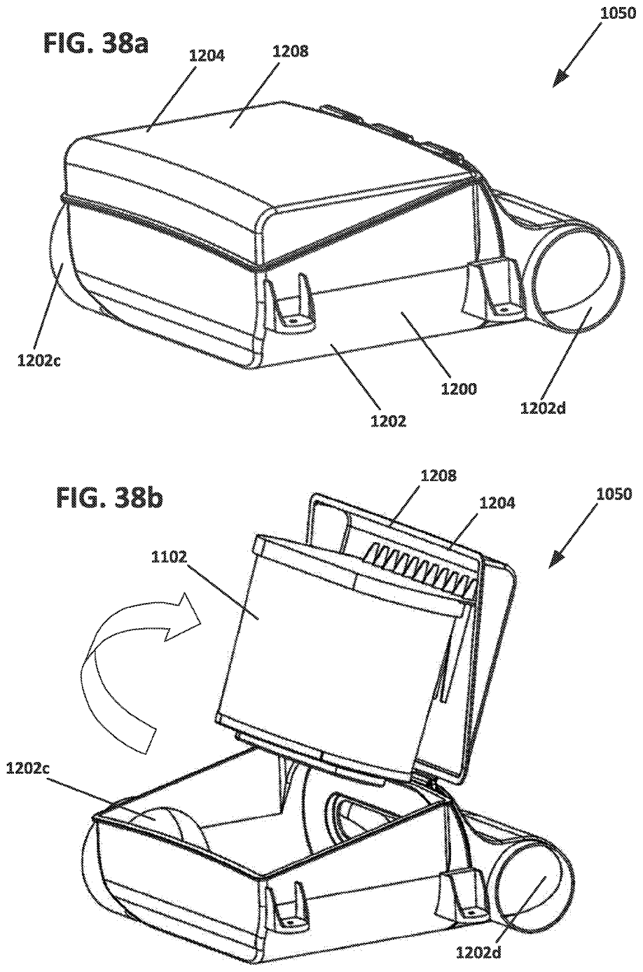

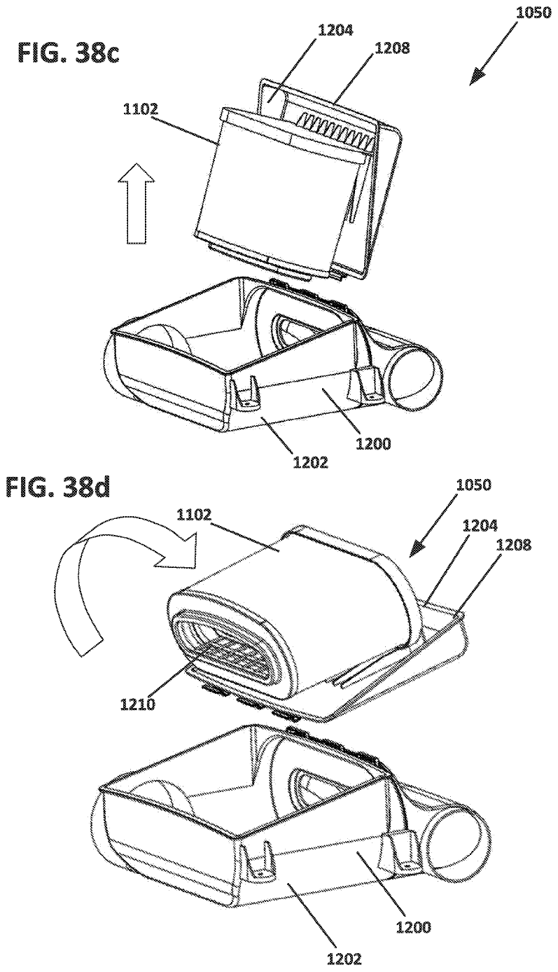

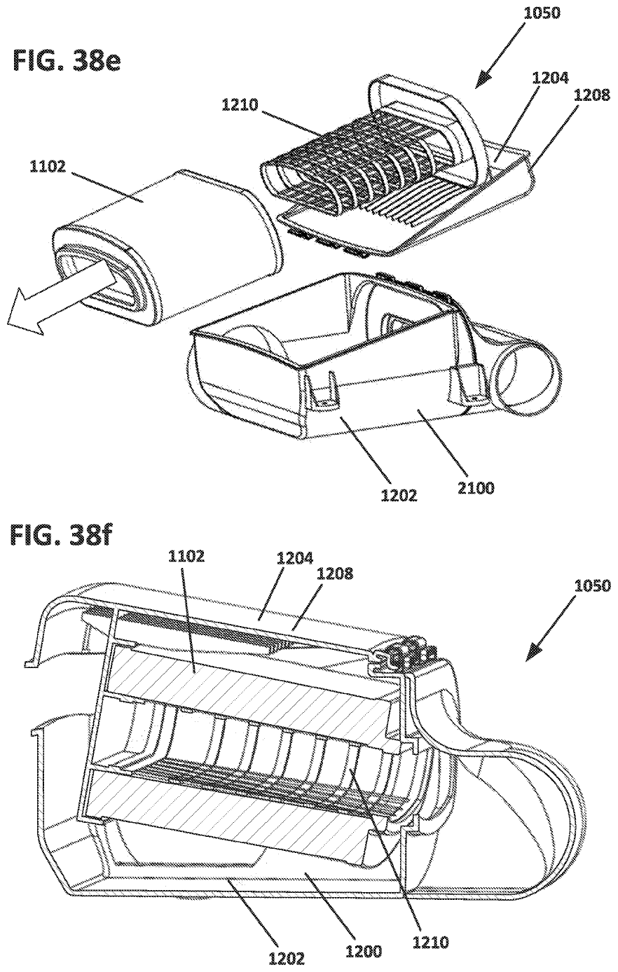

### Air Cleaner Assembly 1050—FIGS. 38a to 38f

FIGS. 38a to 38f illustrate an example of the present disclosure in a schematic manner. As shown, an air cleaner assembly 1050 is presented including a media pack 1100 installable within a housing assembly 1200. Air cleaner assembly 1050 is generally similar to air cleaner assembly 1020 shown in FIGS. 35a to 35c, particularly in that a removable cover assembly 1204 is provided with an integrated cover part 1208 and inner support structure 1210. Accordingly, the description for air cleaner assembly 1020 is also applicable for air cleaner assembly 1050. However, one notable difference between air cleaners 1020 and 1050 is that air cleaner 1050 is similar to air cleaner 1010 in that a sloped service opening 1202b is provided, with a correspondingly shaped cover part 1208, that enables greater access for installation and removal of the media pack 1100.

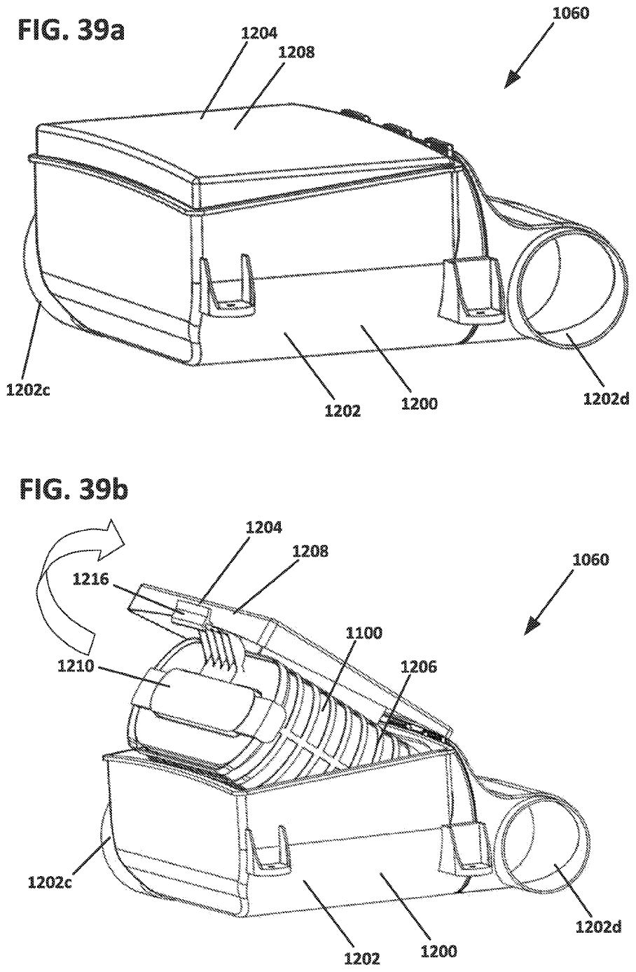

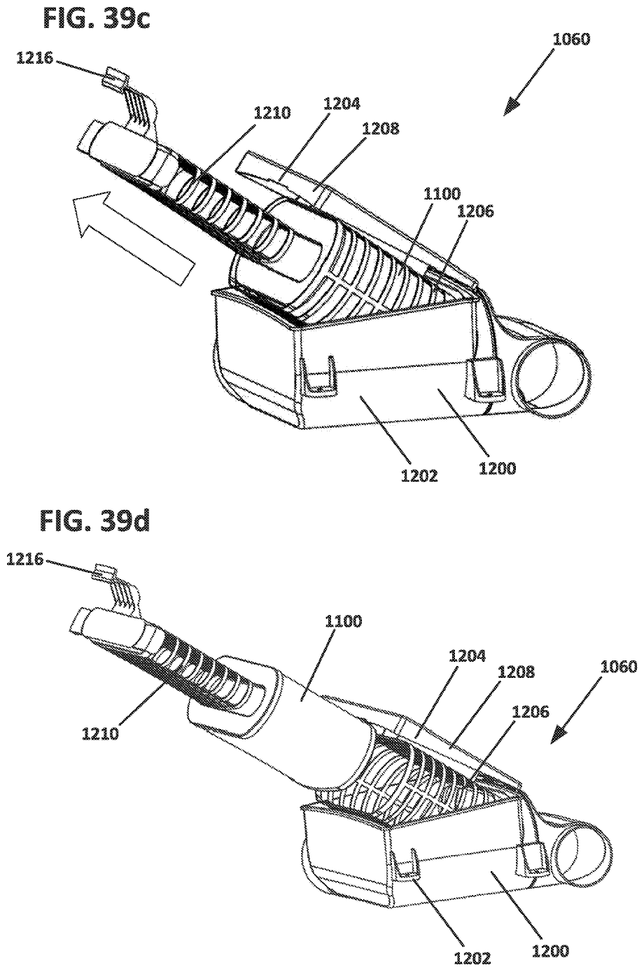

### Air Cleaner Assembly 1060—FIGS. 39a to 39e

FIGS. 39a to 39e illustrate an example of the present disclosure in a schematic manner. As shown, an air cleaner assembly 1060 is presented including a media pack 1100 installable within a housing assembly 1200. The air cleaner assembly 1060 is similar to air cleaner assembly 1030 in that the outer support structure 1206 is formed as part of the cover part 1208 and in that the inner support structure 1210 is provided as a separate end structure 1216 that includes the means for locking or latching the cover assembly 1204 to the main housing 1202. Air cleaner assembly 1060 is similar to air cleaner assembly 1020 and 1050 in that the media pack 1100 is provided with a radially outward sealing surface 1104c on the seal member 1104a that is backed up or supported by the inner support structure 1210. Air cleaner assembly 1060 is also similar to air cleaner assemblies 1010 and 1050 in that a sloped service opening 1202b is provided.

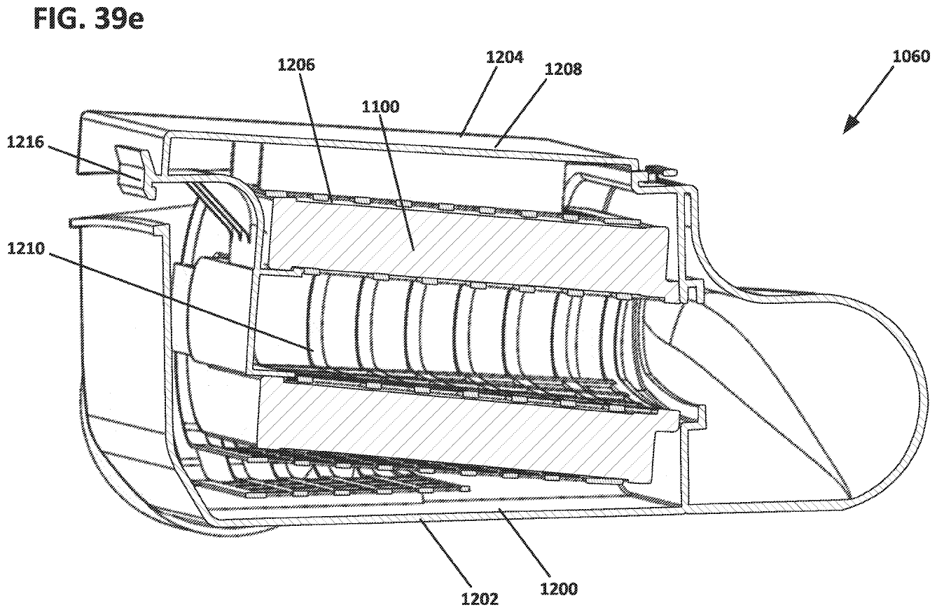

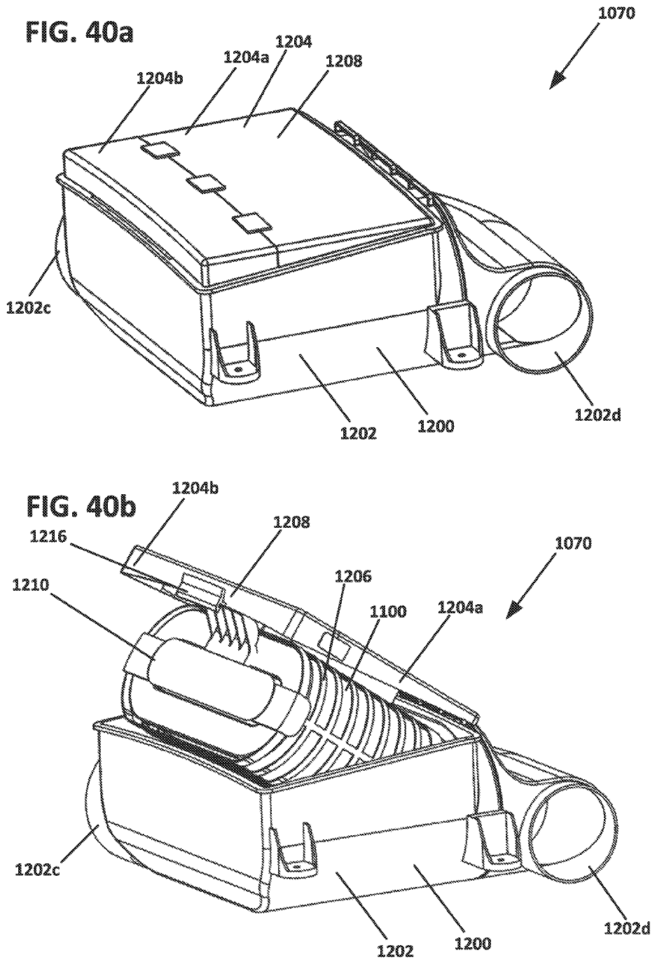

### Air Cleaner Assembly 1070—FIGS. 40a to 40c

FIGS. 40a to 40c illustrate an example of the present disclosure in a schematic manner. As shown, an air cleaner assembly 1070 is presented including a media pack 1100 installable within a housing assembly 1200. The air cleaner assembly 1070 is similar to air cleaner assemblies 1030 and 1050 in that the outer support structure 1206 is formed as part of the cover part 1208 and in that the inner support structure 1210 is provided as a separate end structure 1216 that includes the means for locking or latching the cover assembly 1204 to the main housing 1202. Air cleaner assembly 1070 is similar to air cleaner assemblies 1020 and 1050 in that the media pack 1100 is provided with a radially outward sealing surface 1104c on the seal member 1104a that is backed up or supported by the inner support structure 1210. Air cleaner assembly 1060 is also similar to air cleaner assemblies 1010 and 1050 in that a sloped service opening 1202b is provided. Air cleaner assembly 1070 is different from the other disclosed embodiments in that the end structure 1216 itself forms a portion of the cover part 1204.

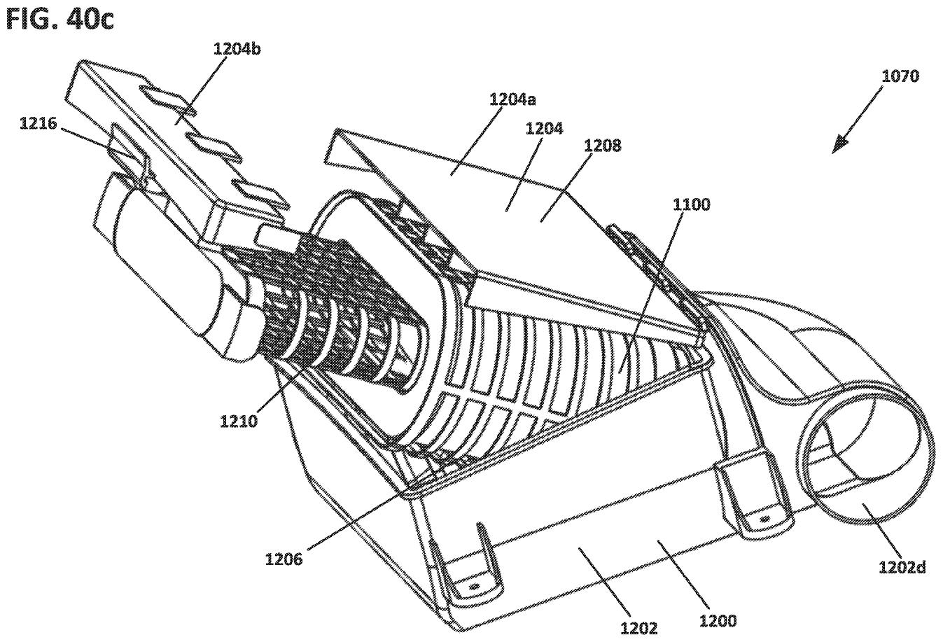

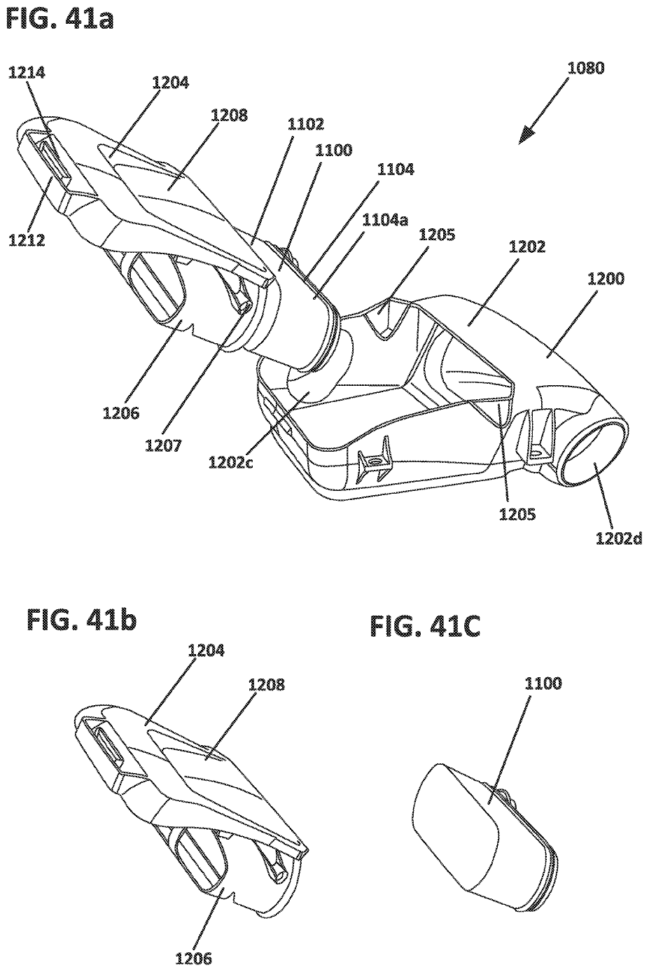

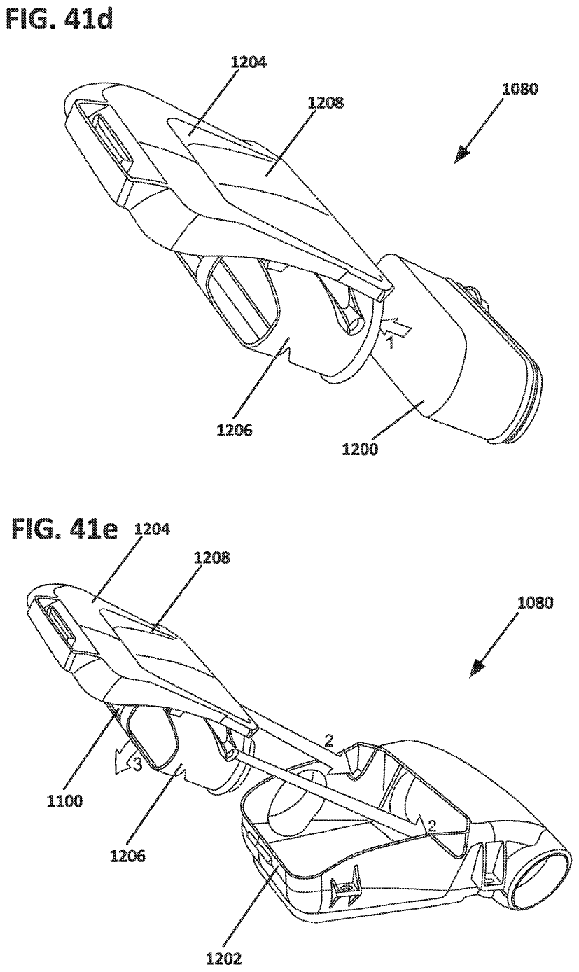

### Air Cleaner Assembly 1080—FIGS. 41a to 41e

FIGS. 41a to 41e illustrate an example of the present disclosure in a schematic manner. As shown, an air cleaner assembly 1080 is presented including a media pack 1100 installable within a housing assembly 1200. The air cleaner assembly 1080 has a main housing 1202 that is configured generally similarly to that shown in FIG. 34a. However, the outer support structure 1206 is provided as part of the cover assembly 1204, which is removable from the main housing 1202, rather than being a component of the housing assembly 1200. With such a configuration, a media pack 1100 having non-pleated media with opposite flow faces (e.g., fluted media) can be utilized in the air cleaner assembly 1080. As the media pack 1100 does not have an open interior area or region, an inner support structure 1210 need not be provided with air cleaner assembly 1080. In the example shown, the end cap 1104 of the media pack 1100 is configured with a seal member 1104a arranged to form a seal with a portion of the main housing 1202. The seal member 1104a can be configured to form an axial seal, radially inward facing seal, and/or a radially outward facing seal with the main housing 1202. Referring to FIGS. 41d and 41e, an installation progression is shown in which: (1) a media pack 1100 is first installed within the outer support structure 1206; (2) the cover assembly 1204 and media pack 1100 are moved into the service opening of the main housing 1102 in a direction that is at an oblique angle to the longitudinal axis of the air cleaner assembly 1080 until a connecting or latching component of the cover assembly 1204 (shown in this example as a pair of pockets 1205) engages with a corresponding connecting or latching component (shown in this example as a pair of tabs 1207) of the main housing 1202; and (3) the cover assembly 1204 and media pack 1100 are rotated in a downward direction to place the media pack 1100 in the installed position with the seal member 1104a engaged with the housing 1200. At this stage, the cover assembly 1204 can be automatically or manually latched or locked to the main housing 1202.

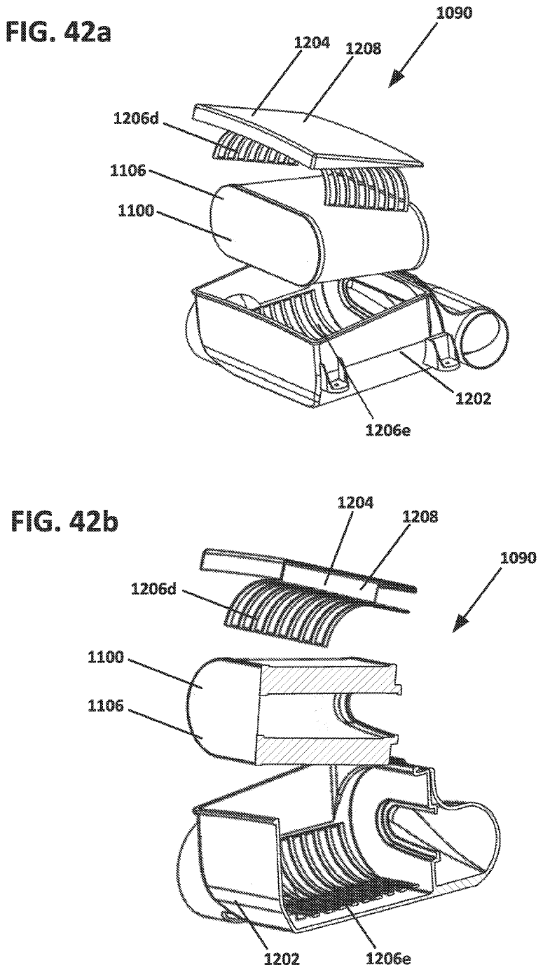

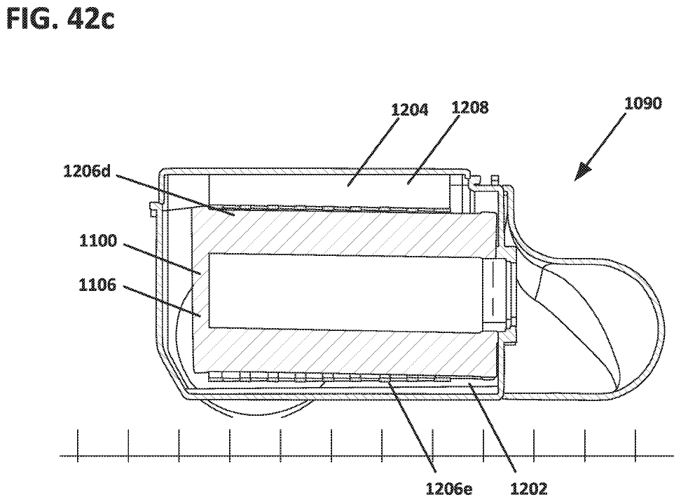

### Air Cleaner Assembly 1090—FIGS. 42a to 42c

FIGS. 42a to 42c illustrate an example of the present disclosure in a schematic manner. As shown, an air cleaner assembly 1090 is presented including a media pack 1100 installable within a housing assembly 1200. Air cleaner assembly 1090 is similar to air cleaner assembly 1040 in that an outer support structure 1206 is provided that is partially defined by the main housing 1202 with portion 1206d and partially defined by the cover part 1208 with portion 1206e. However, air cleaner assembly 1090 differs in that an inner support structure is not shown as being included, although one certainly could be provided. In some examples, the media pack 1100 can be provided with its own internal liner. Air cleaner assembly 1090 is also different from the other disclosed embodiments in that the end cap 1106 is provided as a closed end cap.

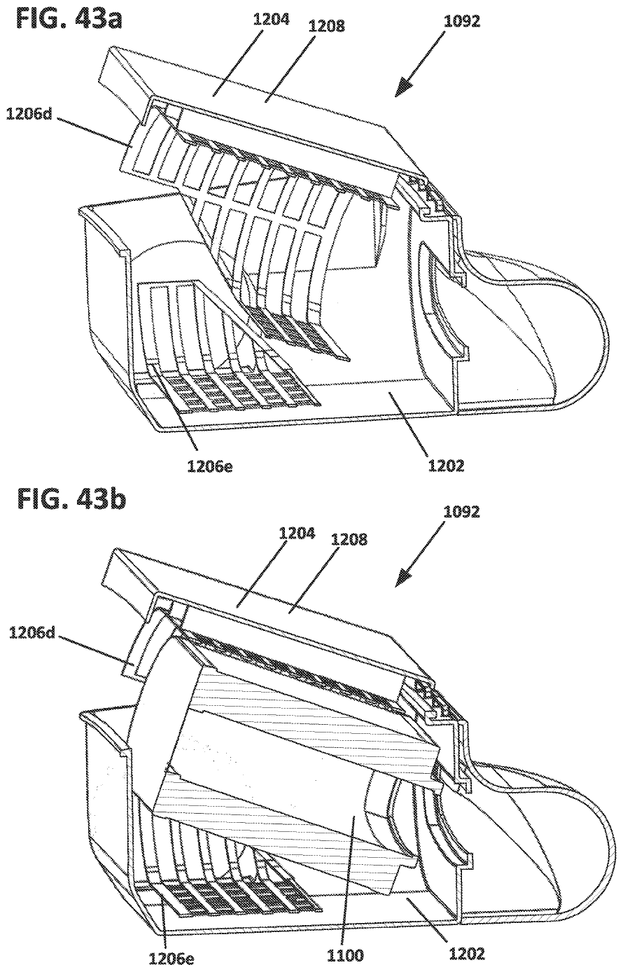

### Air Cleaner Assembly 1092—FIGS. 43a to 43b

FIGS. 43a to 43b illustrate an example of the present disclosure in a schematic manner. As shown, an air cleaner assembly 1092 is presented including a media pack 1100 installable within a housing assembly 1200. Air cleaner assembly 1092 is similar to air cleaner assemblies 1040 and 1090 in that an outer support structure 1206 is provided that is partially defined by the main housing 1202 with portion 1206d and partially defined by the cover part 1208 with portion 1206e. However, air cleaner assembly 1092 differs in that the portion 1206d completely circumscribes one end of the media pack 1100. Accordingly, an operator can load the media pack into the first portion 1206d and then close the cover part 1208, wherein the second portion 1206d will further secure the media pack 1100 in place. In this embodiment, an inner support structure is not shown as being included, although one certainly could be provided. In some examples, the media pack 1100 can be provided with its own internal liner.

### Air Cleaner Assembly 1094—FIGS. 45a to 45d

FIGS. 45a to 45d illustrate an example of the present disclosure in a schematic manner. As shown, an air cleaner assembly 1094 is presented including a media pack 1100 installable within a housing assembly 1200. While the air cleaner assembly 1094 is similar to air cleaner assembly 1010 in that both outer and inner liner structures 1206, 1210 are provided, air cleaner assembly 1094 differs in that the outer liner structure 1206 is associated with the cover part 1208 and the inner liner structure 1210 is associated with the main housing 1202. Air cleaner assembly 1094 further differs from air cleaner assembly 1010 in that the inner liner structure 1210 is rotatably supported by the main housing 1202 and is movable between service and installed positions in a manner generally similar to that shown and described in relation to air cleaner assembly 1040 shown in FIG. 37a. With such a configuration, the media pack 1100 can be first installed within the outer liner structure 1206, as shown in FIG. 45b. Subsequently, the combined cover and media pack assembly can be installed over the inner liner structure 1210, as shown in FIG. 45c. The cover can then rotated into an installed and closed position, as indicated in FIG. 45d. Air cleaner assembly 1094 also differs in that the outer liner structure is provided with a cavity 111 and wall 111b, while the media pack 1100 is provided with a reinforcement structure 21 and a corresponding radial seal extension 221. Accordingly, and as with the other above-described embodiments with such features, the end cap 24 and media of the media pack 1100 must be radially deformed inwardly in a manner similar to that shown in FIG. 33b such that the reinforcement structure 21 can clear the inner edge of the wall 111b. During installation, once this position has been reached, the reinforcement structure 21 is free to extend into the cavity 111. As the end cap 24 is elastically deformable, the end cap 24 will naturally expand into this position once an inward force on the reinforcement structure 21 is removed. It is noted that in the example shown, the reinforcement structure 21 and radial seal extension are provided with a generally trapezoidal shape. Other shapes are possible.

### Air Cleaner Assembly 1096—FIG. 46

FIG. 46 illustrates an example of the present disclosure in a schematic manner. As shown, an air cleaner assembly 1096 is presented including a media pack 1100 installable within a housing assembly 1200. While the air cleaner assembly 1096 is similar to air cleaner assembly 1094 in that both outer and inner liner structures 1206, 1210 are provided, air cleaner assembly 1096 differs in that the inner liner structure 1210 is non-rotatable with respect to the housing 1202, in that the housing 1202 has an open end, and in that the cover 1208 is provided with an L-shape to enclose the top and open end of the housing 1202. Accordingly, once the media pack 1110 has been mounted onto the cover 1208, the assembly is aligned with the inner liner structure 1210 and axially displaced onto the inner liner structure 1210, as indicated in FIG. 46.

For the present disclosure, the terms inlet and outlet have been used for openings in the housing through which the air flow passes “from inlet to outlet”. The skilled person knows that in certain assembly configurations, a reverse flow can be applied, wherein the flow can be in a reverse direction from outlet to inlet. This does not impact the nature of the inventive concepts of the present disclosure.

For instance, the following could be claimed:
1. A filter element (2) comprising a filtration media pack (20) comprising a longitudinal axis, a first open end cap (24) arranged at a first axial end (E1) of the filtration media pack (20) in a fluid tight manner and comprising a central opening (26), wherein the first end cap is at least partially flexible and non-destructively deformable in a radial direction, for instance, between a first shape and a substantially different second shape, and comprises:
   a. a circumferential seal (22) surrounding the opening, wherein the circumferential seal comprises one or more radial seal extensions (221); and
   b. one or more, preferably separate, reinforcement structures (21) at least partially embedded into a material of the first end cap (24) and preferably arranged in respective areas of the one or more radial seal extensions (221).
2. A filter element (2) according to item 1, wherein the one or more reinforcement structures (21) are partially embedded into a material of the first end cap (24), each reinforcement structure (21) covering at least a portion of a corresponding radial extension (221) of the seal (22), the portion comprising at least a radially inner or outer surface (216, 215) of the radial extension (221) and preferably a first axial end surface (213) of the radial extension (221), the first axial end surface projecting towards a second axial end (E2) of the filtration media pack (20).
3. A filter element according to item 1 or 2, wherein the circumferential seal is adapted and arranged for sealing in a radial direction, and wherein the reinforcement structures (21) are arranged and adapted for backing the radial extension (221) of the circumferential seal (22).
4. A filter element according to item 3, wherein a thickness of the seal measured in a direction perpendicular to the axial direction is substantially constant.
5. A filter element according to any of the previous items, wherein one or more or all radial seal extensions are extending radially outwardly.
6. A filter element according to any of the previous items, wherein one or more or all radial seal extensions are extending radially inwardly.
7. A filter element according to any of the previous items, wherein the seal generally follows, for instance, is in axial projection generally concentric with an outer and/or inner contour of the filtration media pack, except for the one or more radial seal extensions (221).
8. A filter element according to any of the previous items, wherein a minimal radial cross-dimension of the second shape of the first open end cap is at least 5% smaller than a minimal radial cross-dimension of the first shape.
9. A filter element according to any of the previous clams, comprising only two radial seal extensions (221) which are arranged at diametrically opposed sides of the circumferential seal (22).
10. A filter element according to item 1, wherein a distance between the radial seal extensions (221) in the second shape is at least 5% smaller or larger than the distance in the first shape.
11. A filter element according to item 1, wherein the end cap has a first width at a first location of the radial seal extension (221) when in the first shape and a second width at the first location when in the second shape, wherein the second width is at least 5% different from the first width with an applied radial force component of 25 N or less.
12. A filter element according to any of the previous items, wherein the first end cap (24) can be deformed in a radial direction by radial force components which are smaller than 40 N.
13. A filter element according to any of the previous items, wherein the each reinforcement structure (21) comprises a hollow cavity (212) in a second axial end surface (214) thereof, the second axial end surface (214) projecting in the same direction as the first end of the filtration media pack (E1).
14. A filter element according to any of the previous items, wherein the first end cap (24) is elastically deformable.
15. A filter element according to any of the previous items, wherein the filtration media pack (20) comprises pleated filtration media, preferably arranged in a tubular manner, and is flexible and preferably elastically deformable.
16. A filter element according to item 15, wherein the filtration media comprises one or more layers selected from the group of media layers and media support layers.
17. A filter element according to any of items 1 to 14, wherein the filtration media pack (20) is of the fluted or z-type.
18. A filter element according to any of the previous items, wherein the first end cap (24), and preferably also the circumferential seal (22), is manufactured by a potting process, preferably a foamed polyurethane potting process, whereby at least a portion of the one or more separate reinforcement structures (21) is embedded in the first end cap (24).
19. A filter element according to any of the previous items, wherein the circumferential seal (22) is formed integrally with the first end cap (24).
20. A filter element according to any of the previous items, wherein the first circumferential seal (22) comprises a two-fold rotational symmetry with respect to the filtration media pack axis.
21. A filter element according to any of the previous items, comprising an axially extending groove (23) in a radially outer surface of the media pack (20), preferably extending from the first end (E1) to the second end (E2).
22. A package comprising a box, bag, or sleeve comprising a filter element according to any of the previous items, wherein the filter element (2) is kept in an elastically deformed configuration by an inner sidewall of the box, bag, or sleeve.
23. A filter assembly (1) comprising a filter housing (10, 11) having an inlet opening (13) and an outlet opening (12), and an internal cavity receiving a filter element (2) according to any of items 1 to 21 in a sealing manner, thereby dividing the internal cavity into a unfiltered air volume fluidly connected to the inlet and a filtered air volume fluidly connected to the outlet by the filtration element, wherein the filter housing comprises a main filter housing (10) and a housing cover (11), wherein the housing cover (11) comprises an outer liner structure (110) for the filter element (2) having a longitudinal axis and projecting from the housing cover (11) into the internal cavity, the outer liner structure (110) receiving the filter element (2) and comprising a proximal end at the housing cover (11) and an opposed distal end (112), and the outer liner structure (110) comprising one or more cavities (111) at its distal end, adapted and arranged for receiving respective one or more composite structures (21, 221) embodied by the one or more radial seal extensions (221) and associated reinforcement structures (21).
24. A filter assembly according to item 23, wherein the filter element comprises an axially extending groove (23) in a radially outer surface of the media pack (20), and wherein the outer liner structure (110) comprises a corresponding axially extending rib or guiding structure (110b) arranged on an internal surface of the outer liner (110).
25. A filter assembly (1) comprising a filter housing (10, 11) having an inlet opening (13) and an outlet opening (14), and an internal cavity receiving a filter element (2) according to any of items 1 to 21 in a sealing manner, thereby dividing the internal cavity into a unfiltered air volume fluidly connected to the inlet and a filtered air volume fluidly connected to the outlet by the filtration element, wherein the filter housing comprises a main filter housing (10) and a housing cover (11), wherein the main filter housing (10) comprises a filter servicing opening defined by a circumferential end portion of the main filter housing (10), wherein the circumferential end portion comprises one or more receiving cavities (115) for receiving respective composite structures (221, 21) embodied by respective radial seal extensions (221) and associated reinforcement structures (21) of the filter element 2.
26. A filter assembly according to item 25, wherein the reinforcement structures (21) comprise radially outwardly extending ribs (211), and wherein the cavities comprise corresponding cavity slots (115a) for receiving the radially outwardly extending ribs (211) and allowing the radially outwardly extending ribs (211) to pass though and to be exposed outside of the main housing (10), wherein the housing cover 11 comprises latches, the latches latching on respective exposed portions of the radially outwardly extending ribs (211).
27. A filter assembly (1) comprising a filter housing (10, 11) having an inlet opening (13) and an outlet opening (12), and an internal cavity receiving a filter element (2) according to any of items 1 to 21 in a sealing manner, thereby dividing the internal cavity into a unfiltered air volume fluidly connected to the inlet and a filtered air volume fluidly connected to the outlet by the filtration element, wherein the filter housing comprises a main filter housing (10) and a housing cover (11), wherein the main filter housing (10) comprises an inner liner (14) for the filter element (2) having a longitudinal axis and projecting from the main housing (10) into the internal cavity, the inner liner structure (14) being received by an internal cavity of the filter element (2) and comprising a proximal end at the main housing (10) and an opposed distal end, and the inner liner (14) comprising one or more cavities (141) at its distal end, adapted and arranged for receiving respective one or more composite structures (21, 221) embodied by the one or more radial seal extensions (221) and associated reinforcement structures (21).
28. A filter assembly (1) comprising a filter element (2) according to any of the previous items 1 to 21 and a separate, removable outer liner (110) for the filter element (2), wherein the outer liner (110) extends in an axial direction between a first axial end and a second axial end and comprises an internal volume for receiving the filter element (2), wherein the outer liner comprises one or more cavities (111′) at the first axial end receiving the one or more respective composite structures (221, 21) embodied by respective radial seal extensions (221) and associated reinforcement structures (21) of the filter element 2.
29. A filter assembly (1) comprising a filter element (2) according to any of the previous items 1 to 21 and a separate, removable inner liner (14) for the filter element (2), wherein the inner liner (14) extends in an axial direction between a first axial end and a second axial end, and the filter element (2) comprises an internal volume for receiving the inner liner (14), wherein the inner liner comprises one or more cavities (141′) at the first axial end receiving the one or more respective composite structures (221, 21) embodied by respective radial seal extensions (221) and associated reinforcement structures (21) of the filter element (2).
30. A filter assembly according to any of items 23 to 29, wherein the one or more cavities (111, 141, 111′, 141′, 115) form an undercut portion preventing the composite structures (21, 221) from being inserted into the cavities (141′) without deforming the filter element (2).
31. A filter assembly (1) comprising a filter housing (10, 11) having an inlet opening (13) and an outlet opening (12), and an internal cavity receiving a filter element (2) according to any of items 1 to 21 in a sealing manner, thereby dividing the internal cavity into a unfiltered air volume fluidly connected to the inlet and a filtered air volume fluidly connected to the outlet by the filtration element, wherein the filter housing comprises a main filter housing (10) and a housing cover (11), wherein the housing cover (11) comprises an outer liner structure (110) for the filter element (2) having a longitudinal axis and projecting from the housing cover (11) into the internal cavity, the outer liner structure (110) receiving the filter element (2) and comprising a proximal end at the housing cover (11) and an opposed distal end (112), and the outer liner structure (110) comprising one or more undercut portions (110a) at its distal end, adapted and arranged for preventing the composite structures (21, 221) embodied by the one or more radial seal extensions (221) and associated reinforcement structures (21) from passing from one side to the opposed side of the undercut (110a) portions without deforming the filter element (2).
32. A filter assembly according to item 31, wherein the filter element comprises an axially extending groove (23) in a radially outer surface of the media pack (20), and wherein the outer liner structure (110) comprises a corresponding axially extending rib or guiding structure (110b) arranged on an internal surface of the outer liner (110).

### CONCLUSION

The principles described herein can be applied in a variety of filter assemblies. Examples described in which the principles applied to (air) gas filter assemblies. Examples are described include air filters, for example, air filters used for treating engine intake airflows. The principles can be applied to a variety of alternate gas filtration arrangements, in some instances even with liquid filter assemblies. Again, the principles, techniques, and features described herein can be applied in a variety of systems, and there is no requirement that all of the advantageous features identified be incorporated in an assembly, system or component to obtain some benefit according to the present disclosure.

1. A filter element comprising a filtration media pack comprising a longitudinal axis, a first open end cap arranged at a first axial end of the filtration media pack in a fluid tight manner and comprising a central opening wherein said first end cap is at least partially flexible and non-destructively deformable in a radial direction between a first shape and a substantially different second shape, and comprises:
a) a circumferential seal surrounding said opening, wherein said circumferential seal comprises one or more radial seal extensions and
b) one or more reinforcement structures at least partially embedded into a material of said first end cap and preferably arranged in respective areas of said one or more radial seal extensions

2. A filter element according to claim 1, wherein said one or more reinforcement structures are partially embedded into a material of said first end cap, each reinforcement structure covering at least a portion of a corresponding radial seal extension of said circumferential seal, said portion comprising at least a radially inner or outer surface of said radial seal extension and preferably a first axial end surface of said radial seal extension, said first axial end surface projecting towards a second axial end of said filtration media pack.

3. A filter element according to claim 1, wherein said circumferential seal is adapted and arranged for sealing in a radial direction, and wherein said one or more reinforcement structures are arranged and adapted for backing said one or more radial seal extensions of said circumferential seal.

4. A filter element according to claim 3, wherein a thickness of said seal, measured in a direction perpendicular to said axial direction, is substantially constant.

5. A filter element according to claim 1, wherein one or more or all the radial seal extensions are extending radially outwardly.

6. A filter element according to claim 1, wherein one or more or all the radial seal extensions are extending radially inwardly.

7. A filter element according to claim 2, wherein each said reinforcement structure comprises a hollow cavity in a second axial end surface thereof, said second axial end surface projecting in the same direction as said first end of said filtration media pack.

8. A package comprising a box, a bag, or a sleeve comprising a filter element according to claim 1, wherein the filter element is kept in an elastically deformed configuration by an inner sidewall of the box, bag, or sleeve.

9. A filter assembly comprising a filter housing having an inlet opening and an outlet opening and an internal cavity receiving a filter element according to claim 1, in a sealing manner, thereby dividing said internal cavity into an unfiltered air volume fluidly connected to said inlet opening and a filtered air volume fluidly connected to said outlet opening by said filter element, wherein said filter housing comprises a main filter housing and a housing cover, wherein said housing cover comprises an outer liner structure for said filter element having a longitudinal axis and projecting from said housing cover into said internal cavity, said outer liner structure receiving said filter element and comprising a proximal end at said housing cover and an opposed distal end, and said outer liner structure comprising one or more cavities at its distal end, adapted and arranged for receiving respective one or more composite structures embodied by said one or more radial seal extensions and associated reinforcement structures.

10. A filter assembly comprising a filter housing having an inlet opening and an outlet opening and an internal cavity receiving a filter element according to claim 1 in a sealing manner, thereby dividing said internal cavity into an unfiltered air volume fluidly connected to said inlet opening and a filtered air volume fluidly connected to said outlet opening by said filter element, wherein said filter housing comprises a main filter housing and a housing cover, wherein said main filter housing comprises a filter servicing opening defined by a circumferential end portion of said main filter housing, wherein said circumferential end portion comprises one or more receiving cavities for receiving respective composite structures embodied by respective radial seal extensions and associated reinforcement structures of said filter element.

11. A filter assembly comprising a filter housing having an inlet opening and an outlet opening, and an internal cavity receiving a filter element according to claim 1 in a sealing manner, thereby dividing said internal cavity into an unfiltered air volume fluidly connected to said inlet opening and a filtered air volume fluidly connected to said outlet opening by said filter element, wherein said filter housing comprises a main filter housing and a housing cover, wherein said main filter housing comprises an inner liner for said filter element having a longitudinal axis and projecting from said main housing into said internal cavity, said inner liner structure being received by an internal cavity of said filter element and comprising a proximal end at said main housing and an opposed distal end, and said inner liner comprising one or more cavities at its distal end, adapted and arranged for receiving respective one or more composite structures embodied by said one or more radial seal extensions and associated reinforcement structures.

12. A filter assembly comprising a filter element according to claim 1, and a separate, removable outer liner for said filter element, wherein said outer liner extends in an axial direction between a first axial end and a second axial end and comprises an internal volume for receiving said filter element, wherein said outer liner comprises one or more cavities at said first axial end receiving one or more respective composite structures embodied by respective radial seal extensions and associated reinforcement structures of said filter element.

13. A filter assembly comprising a filter element according to claim 1, and a separate, removable inner liner for said filter element, wherein said inner liner extends in an axial direction between a first axial end and a second axial end, and said filter element comprises an internal volume for receiving said inner liner, wherein said inner liner comprises one or more cavities at said first axial end receiving one or more respective composite structures embodied by respective radial seal extensions and associated reinforcement structures of said filter element.

14. A filter assembly according to claim 12, wherein said one or more cavities form an undercut portion preventing said composite structures from being inserted into said cavities without deforming said filter element.

15. A filter assembly comprising a filter housing having an inlet opening and an outlet opening, and an internal cavity receiving a filter element according to claim 1 in a sealing manner, thereby dividing said internal cavity into an unfiltered air volume fluidly connected to said inlet opening and a filtered air volume fluidly connected to said outlet opening by said filter element, wherein said filter housing comprises a main filter housing and a housing cover, wherein said housing cover comprises an outer liner structure for said filter element having a longitudinal axis and projecting from said housing cover into said internal cavity, said outer liner structure receiving said filter element and comprising a proximal end at said housing cover and an opposed distal end, and said outer liner structure comprising one or more undercut portions at its distal end, adapted and arranged for preventing said composite structures embodied by said one or more radial seal extensions and associated reinforcement structures from passing from one side to an opposite side of said undercut portions without deforming said filter element.

16-32. (canceled)

33. A filter element comprising:
a) a filtration media pack comprising a longitudinal axis; and
b) a first open end cap arranged at a first axial end of the filtration media pack in a fluid tight manner and comprising a central opening, the first open end cap including a circumferential seal surrounding said opening, wherein said circumferential seal comprises a radial seal extension and
c) wherein the first end cap is non-destructively deformable in a first radial direction between a non-deformed state and a deformed state, wherein the end cap has a first width along a first axis passing through the longitudinal axis and the radial seal extension when in the first shape and a second width along the first axis when in the deformed state, wherein the second width is at least 5% different from the first width with an applied radial force component of 25 N or less.

34. The filter element of claim 33, wherein the second width is at least 10% different from the first width with an applied radial force of 45 N or less.

35. The filter element of claim 33, or further comprising:
a) a reinforcement structure secured to the end cap proximate the radial seal extension, the reinforcement structure preventing deformation of the radial seal extension when the first end cap is in the deformed state.

36. The filter element of claim 33, wherein the first end cap has a third width extending along a second axis orthogonal to the first axis and passing through the longitudinal axis, wherein the first end cap can be deformed from the non-deformed state to the deformed state without requiring a change in the third width.

37. The filter element of claim 33, wherein the filter element is provided without an inner liner and/or without an outer liner.

38. The filter element of claim 33, wherein the first end cap has single fold symmetry.

39-65. (canceled)

66. A filter element comprising:
a) a media pack defining an outer surface and extending along a longitudinal axis between a first end and a second end;
b) a seal member having a first hardness and being operably arranged on the media pack proximate the first end, the seal member presenting opposite radially inward and radially outward facing surfaces, the radially inward or outward facing surface being a seal surface; and
c) a reinforcement member extending partially along the seal member radially inward or outward facing surface that is opposite the seal surface such that the radial inward or outward facing surface has a first lengthwise segment covered by the reinforcement member and a second lengthwise segment that is uncovered by the reinforcement member.

67. The filter element of claim 66, wherein the reinforcement member is at least partially embedded within the seal member.

68. The filter element of claim 66, wherein the seal member includes one or more of a radial inward step and a radial outward step.

69. The filter element of claim 66, further comprising one or more handles.
